(19) United States
(12) Patent Application Publication
(10) Pub. No.: US 2024/0024828 A1
(43) Pub. Date: Jan. 25, 2024

(54) HALOGEN-SUBSTITUTED 9,9-BIS(4-AMINOPHENYL)FLUORENE BASED POLYIMIDE MEMBRANES FOR GAS SEPARATION APPLICATIONS

(71) Applicant: Saudi Arabian Oil Company, Dhahran (SA)

(72) Inventors: Ali Hayek, Dhahran (SA); Abdulkarim Alsamah, Dhahran (SA)

(21) Appl. No.: 17/872,711

(22) Filed: Jul. 25, 2022

(51) Int. Cl. B01D 71/64; B01D 71/80; B01D 53/22; C08G 73/10; C10L 3/10

(52) U.S. Cl. CPC B01D 71/64; B01D 71/80; B01D 53/228; C08G 73/1067; C10L 3/101; C10L 2290/548

(57) ABSTRACT

Embodiments described in examples herein provide a gas separation membrane including a polyimide polymer including a monomer having a structure including:

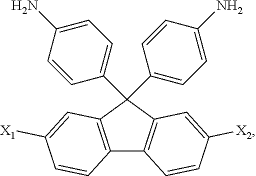

wherein when X₁=X₂, X₁ and X₂ are selected from F, Cl, Br, or I and wherein when X₁ and X₂ are different elements, X₁ and X₂ are independently selected from H, F, Cl, Br, or I.

### TECHNICAL FIELD

The present disclosure is directed to polymers for gas separation membranes. More specifically, the polymers include polymers based on a halogen-substituted 9,9-bis(4-aminophenyl)fluorene (CARDO) for use in gas purification technologies.

### BACKGROUND

Natural gas supplies 22% of the energy used worldwide, and makes up nearly a quarter of electricity generation. Further, natural gas is an important feedstock for the petrochemicals industry. According to the International Energy Agency (IEA), the worldwide consumption of natural gas is projected to increase from 120 trillion cubic feet (Tcf) in the year 2012 to 203 Tcf by the year 2040.

Raw, or unprocessed, natural gas is formed primarily of methane (CH₄), however it may include significant amounts of other components, including acid gases (carbon dioxide (CO₂) and hydrogen sulfide (H₂S)), nitrogen, helium, water, mercaptans, and heavy hydrocarbons (C₃₊), among other components. These contaminants must be removed during gas processing in order to meet the standard pipeline specifications of sales gas. In particular, the removal of acid gases (CO₂ and H₂S) has been a significant research topic due to the problematic effects of acid gases on natural gas heating value, pipeline transportability, and pipeline corrosion in the presence of water.

Currently, the majority of gas processing plants remove CO₂ and H₂S from natural gas by absorption technology, such as amine adsorption. However, several drawbacks are associated with this technology, including energy usage, capital cost, maintenance requirements, and the like.

### SUMMARY

Embodiments described in examples herein provide a gas separation membrane including a polyimide polymer including a monomer having a structure including:

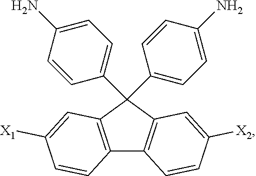

wherein when X₁=X₂, X₁ and X₂ are selected from F, Cl, Br, or I and wherein when X₁ and X₂ are different elements, X₁ and X₂ are independently selected from H, F, Cl, Br, or I.

Another embodiment described in examples herein provides a method for forming a gas separation membrane. The method includes obtaining a halogen-substituted 9,9-bis(4-aminophenyl)fluorene (CARDO) monomer and obtaining an dianhydride monomer. The halogen-substituted 9,9-bis(4-aminophenyl)fluorene (CARDO) monomer is reacted with the dianhydride monomer to form a polymer. The polymer is dissolved in a solvent to form a polymer solution. A film is formed from the polymer solution. The film is dried to form the gas separation membrane.

### BRIEF DESCRIPTION OF DRAWINGS

FIG. 1 is a schematic representation of the solution-diffusion process across a polymeric membrane.

FIG. 2 is a general synthetic scheme for forming a halogen-substituted 9,9-bis(4-aminophenyl)fluorene (CARDO) moiety.

FIG. 3 are drawings of chemical structures for symmetric halogen-substituted CARDO diamine monomers.

FIG. 4 are drawings of chemical structures for asymmetric halogen-substituted CARDO diamine monomers.

FIG. 5 is a general synthetic scheme for forming halogen-substituted, CARDO-based homopolyimides.

FIG. 6 is a synthetic scheme for forming halogen-substituted, CARDO-based co-polyimides.

FIG. 7 are drawings of chemical structures for dianhydride monomers.

FIG. 8 are drawings of chemical structures for aromatic diamine comonomers.

FIG. 9 is a synthetic scheme for forming the 4,4′-(2,7-dibromo-9H-fluorene-9,9-diyl)dianiline [CARDO(Br)] according to Example 1.

FIG. 10 is a synthetic scheme for forming the homopolymer 6FDA-CARDO(Br) according to Example 2.

FIG. 11 is a synthetic scheme for forming the (1:1) block copolyimide 6FDA-Durene/6FDA-CARDO(Br) according to Example 3.

FIG. 12 is a synthetic scheme for forming the (1:1) block copolyimide 6FDA-Durene/6FDA-CARDO(Br) according to Example 6.

FIG. 13 is a ¹H NMR spectrum of 4,4′-(2,7-dibromo-9H-fluorene-9,9-diyl)dianiline [CARDO(Br)] in DMSO-d6.

FIG. 14 is an FTIR spectrum of CARDO(Br) monomer.

FIG. 15 is a ¹H NMR spectrum of 6FDA-CARDO(Br) homopolymer in CDCl₃.

FIG. 16 is a ¹H NMR spectrum of 6FDA-Durene/6FDA-CARDO(Br) (1:1) copolymer in CDCl₃.

FIG. 17 is a plot of normalized FTIR spectra of 6FDA-CARDO(Br) homopolyimide and a series of 6FDA-Durene/6FDA-CARDO(Br) copolyimides at different composition ratios (x:1) (the present polymers).

FIG. 18A is a plot of the thermogravimetric analysis (TGA) curves and the first derivative curves (DTG) of the present polymers.

FIG. 18B is a plot of the differential scanning calorimetric (DSC) curves for the present polymers.

FIG. 19 is a simplified process flow diagram of a continuous-flow gas permeation device used for measuring single gas and mixed gas permeation properties.

FIG. 20 is a plot comparing the CO₂/CH₄ permeability-selectivity “trade-off” curve of Robeson to the present polymers.

FIG. 21A is a plot comparing the effects of feed gas pressure on the CO₂ permeability of series of 6FDA-Durene/6FDA-CARDO(Br) copolyimides at three different composition ratios at 22° C.

FIG. 21B is a plot comparing the CO₂/CH₄ selectivity (right) coefficients of Durene:CARDO(Br) copolyimides at three different composition ratios at different feed pressures and 22° C.

FIG. 22A is a plot of the effect of feed gas pressure on the sweet mixed-gas CO₂ and CH₄ permeability of 6FDA-DAM/6FDA-CARDO(Br) (3:1) copolyimide at 22° C.

FIG. 22B is a plot of the effect of feed gas pressure on the CO₂/CH₄ selectivity coefficients of 6FDA-DAM/6FDA-CARDO(Br) (3:1) copolyimide at 22° C.

FIG. 23 is a plot showing a comparison between sweet mixed-gas CO₂ permeability and CO₂/CH₄ selectivity coefficients of 6FDA-Durene/6FDA-CARDO(Br) (3:1) and 6FDA-DAM/6FDA-CARDO(Br) (3:1) copolyimides at different feed pressures and 22° C.

FIG. 24 is a method for synthesizing and using a polymer for forming a membrane to separate a gas mixture.

### DETAILED DESCRIPTION

As separation technologies advance, the use of gas separation technologies based on polymeric membranes has been increasingly explored due to the potential for increased energy efficiency over current technologies, a small footprint, and a low capital cost. Although current membrane technologies do not outperform absorption systems, hybrid systems using absorption and membranes have proved to be a potentially attractive alternative. For membrane systems, it is desirable to have polymeric membranes with improved separation performance.

Polymeric membranes are thin semipermeable barriers that selectively separate some gas compounds from others. Generally, polymeric membranes do not operate as a filter, where small molecules are separated from larger ones through a medium with pores, rather it separates based on how well different compounds dissolve into the membrane and diffuse through it, for example, using a solution-diffusion model.

New membrane polymers and methods for synthesizing the polymers and forming membranes from the polymers are provided in examples herein. The polymers are based on halogen-substituted 9,9-bis(4-aminophenyl)fluorene (CARDO) moieties. The membranes formed from these polymers are intended to improve the performance of polymeric membranes for use in natural gas separation application. The materials will enhanced the productivity, efficiency, and resistance to plasticization of the membranes at elevated operational conditions of pressure and temperature, during sweet and/or sour mixed-gas separation. This will reduce the capital expenditures (CAPEX) and operating expenditures (OPEX) of the membrane-based natural gas purification process.

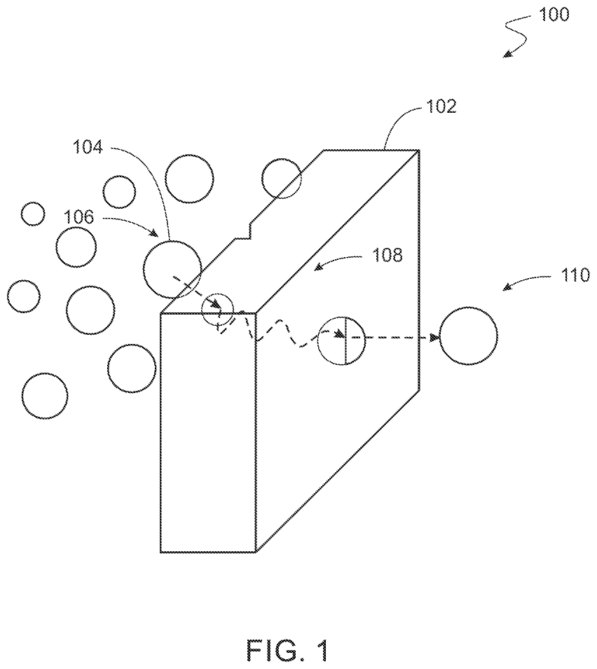

FIG. 1 is a schematic drawing 100 of the solution-diffusion process across a polymeric membrane 102. In this process, a gas molecule 104 sorbs 106 into the membrane polymeric 102, then diffuses 108 through the thin membrane matrix, to end up desorbing 110 from the other side of the polymeric membrane 102.

Numerous polymeric membranes for gas separation have been developed in the decades, but few are currently commercialized for use in sour gas separation applications. Examples of polymeric materials used to form gas separation membranes include cellulose acetate (CA), polyimides (PI), and perfluoropolymers, such as polytetrafluoroethylene (PTFE), perfluorocycloalkene (PFCA), and the like. These polymeric materials are generally semi-crystalline polymers having a T_{g} of greater than about 100° C.

One of the main characteristics used for selection of the polymeric materials is the chemical structure. Various classes of polymers have been studied for use in gas separation membranes, such as sour mixed-gas separation. Materials that have been tested include polyimides and polyoxadiazoles. A successful candidate will form membranes with high CO₂ and H₂S permeability coefficients and high to moderate CO₂/CH₄ and H₂S/CH₄ selectivity coefficients, while withstanding the harsh chemical, physical, and thermal conditions encountered during the purification of natural gas.

One way of improving the membrane performance is by tailoring the properties of the polymeric material forming the membrane by to increase the dynamic free volume of the membrane by adding bulky groups or a heteroatom with larger size than carbon atom. Tailoring may also be used to improve the gas-polymer affinity by increasing the polarity within the polymer backbone.

This methodology can be used to allow the polymeric material to deal with each type of gas molecule in a distinct manner. For example, the dynamic free volume within the membrane matrix can separate the gas molecules based on the difference of their sizes (i.e., kinetic diameters, Dₖ) according to a kinetic phenomenon (i.e., rate of diffusion), since methane (Dₖ=3.80 Å, the main component of natural gas) is larger in size than the undesired existent impurities in natural gas (i.e., Dₖ=3.30 Å for CO₂ and Dₖ=3.60 Å for H₂S). Further, improving the gas-polymer affinity increases the solubility of polar gas molecules, such as H₂S, or molecules containing polar bonds, such as CO₂, to improve the permeation through the membrane matrix, while not influencing the transport of methane.

Halogen atoms, such as fluorine (F, atomic radii=64 pm; electronegativity=3.98), chlorine (Cl, atomic radii=99 pm; electronegativity=3.16), bromine (Br, atomic radii=114 pm; electronegativity=2.96) and iodine (I, atomic radii=133 pm; electronegativity=2.66) are known for their increased polarity and most are larger than carbon atoms (C, atomic radii=77 pm; electronegativity=2.55), with the exception of fluorine, which is smaller in size than carbon, but with much higher electronegativity. Thus, adding halogen atoms to the polymer backbone leads to fine-tune the diffusivity and solubility of gas molecules by increasing the dynamic free volume within the membrane matrix and the gas-polymer affinity, respectively. The techniques described herein improve the sweet and sour mixed-gas separation properties of polymeric membranes and their resistance to plasticization at elevated feed pressures, by developing new halogen-substituted CARDO-based polyimides

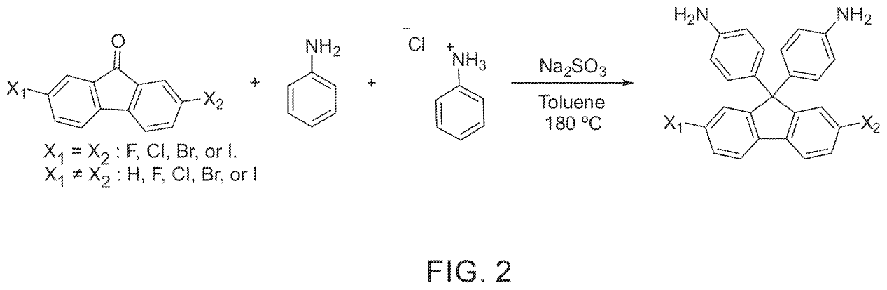

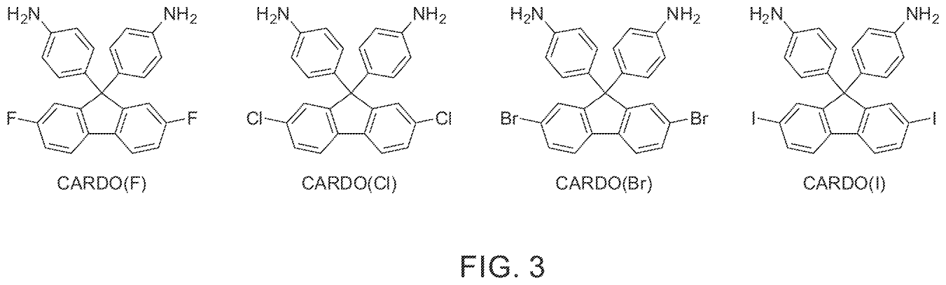

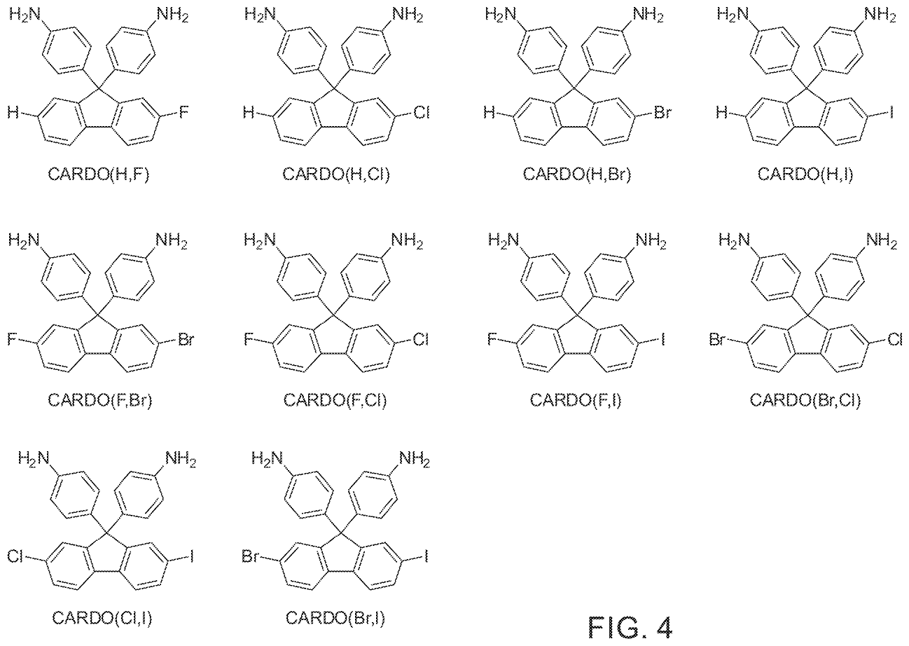

FIG. 2 is a general synthetic scheme for forming a halogen-substituted 9,9-bis(4-aminophenyl)fluorene (CARDO) moiety. This invention describes the preparation of polyimides structures containing a halogen-substituted CARDO moiety. The halogen atoms are placed in the 2 and 7 positions of the fluorenyl group of the 9,9-bis(4-aminophenyl)fluorene (CARDO) moiety to serve as polar bulky groups, which can simultaneously improve the solubility and diffusivity of gas molecules through the polymeric matrix of their membranes. The halogen substitution the 2 and 7 positions may be symmetrical or asymmetrical. FIG. 3 are drawings of chemical structures for symmetric halogen-substituted CARDO diamine monomers. In some embodiments, the halogen-substitution of the CARDO moiety is symmetric, e.g., X₁=X₂. In these structures, both X₁ and X₂ are halogen atoms. FIG. 4 are drawings of chemical structures for asymmetric halogen-substituted CARDO diamine monomers. In some embodiments, the halogen-substitution of the CARDO moiety is asymmetric, e.g., X₁≠X₂, examples of which are shown in FIG. 4. For these structures, one of X₁ or X₂ can be a hydrogen atom, with the other being a halogen atom, or both of them are different halogen atoms.

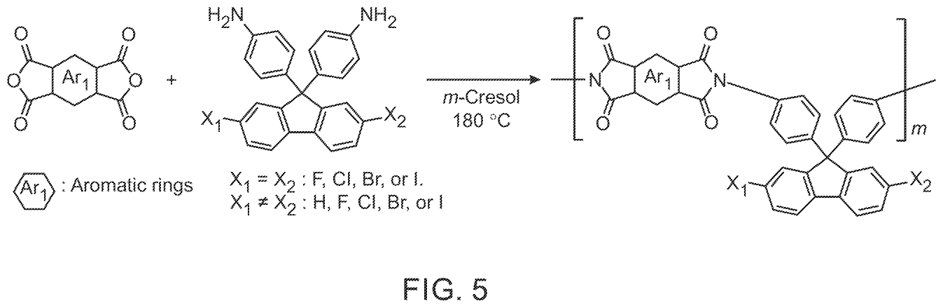

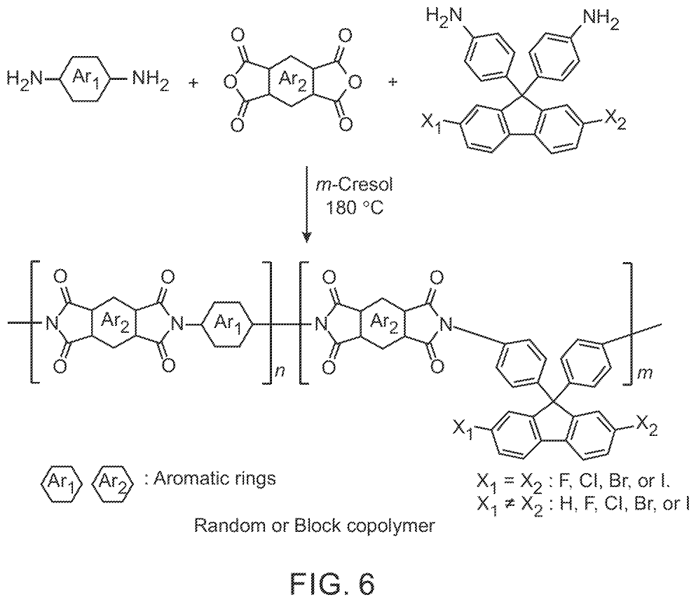

The prepared halogen-substituted CARDO moieties are reacted with a variety of dianhydride moieties to form polymer, such as homopolyimides, as shown in FIG. 5, or copolyimides, as shown in FIG. 6. In some embodiments, both symmetric and asymmetric halogen-substituted CARDO moieties are used to form the polymers, allowing the separation properties of the membrane to be tailored.

FIG. 5 is a general synthetic scheme for forming halogen-substituted, CARDO-based homopolyimides. The reaction may be carried out in m-cresol at an elevated temperature (180° C.-200° C.). Other solvents may be used, such as n-methyl pyrrolidone (NMP) and dimethylacetamide (DMAc).

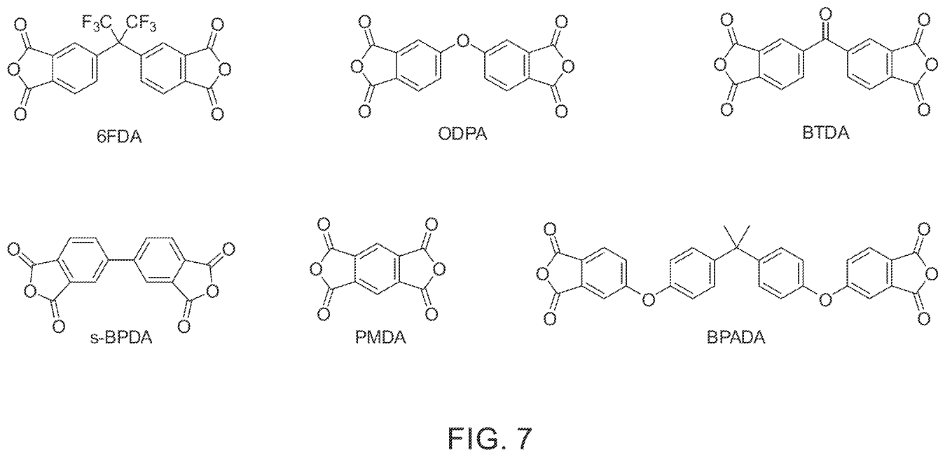

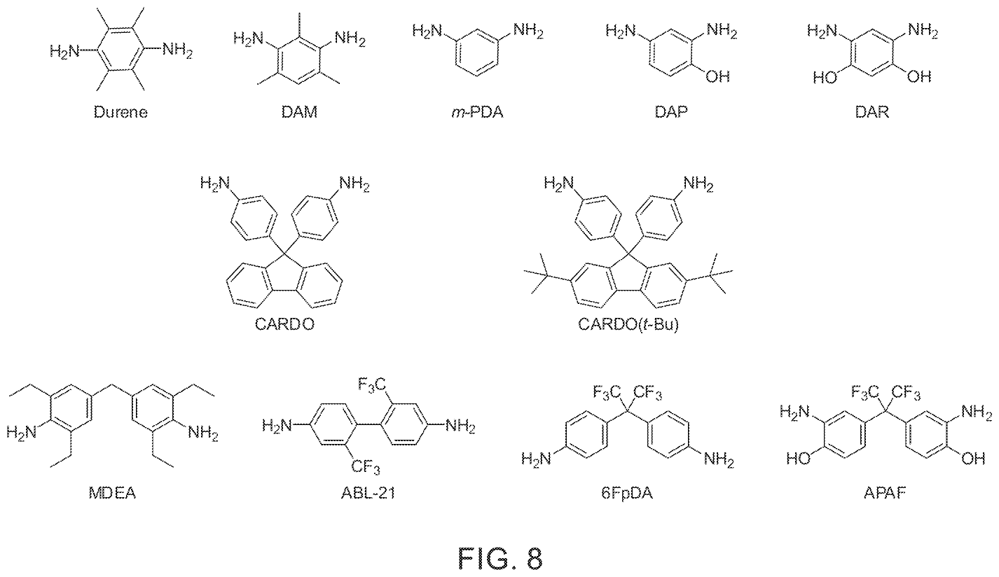

FIG. 6 is a synthetic scheme for forming halogen-substituted, CARDO-based co-polyimides. The copolyimides are prepared by using a halogen-substituted CARDO moiety and a dianhydride monomer, e.g., as shown in FIG. 7, in addition to another diamine comonomer, e.g., as shown in FIG. 8.

The copolymerization is a synthetic methodology that aims to combine the gas permeation properties of two separate homopolymers into a single copolymer. The second diamine comonomer is chosen to complement the properties provided by the halogen-substituted CARDO-based homopolyimide to either improve the permeability or selectivity of the copolyimide membrane.

As described herein, for natural gas purification, it is useful to improve the permeability of impurities [such as carbon dioxide (CO₂) and hydrogen sulfide (H₂S)] and the membrane selectivities (CO₂/CH₄ and H₂S/CH₄) toward the main hydrocarbon constituting the natural gas; methane (CH₄). In another aspect, it is desired to increase the plasticization resistance of polymeric membranes during high-pressure mixed-gas separation. The halogen polar groups are intended to form a dipole-dipole type interaction between the polymeric chains, which limits their mobility under harsh separation conditions of temperature and pressure. This strategy has proven to improve the permeation properties and plasticization resistance of the polymeric membranes during mixed-gas separation at high feed pressure.

FIG. 7 are drawings of chemical structures for dianhydride monomers. Various dianhydride monomers can be used to form the polymers and copolymers described herein, including, for example, but not limited to those shown in FIG. 7

FIG. 8 are drawings of chemical structures for aromatic diamine comonomers. For the preparation of the copolyimides described in this invention, various diamine comonomers are combined with the dianhydride and halogen-substituted CARDO monomers can be used to provide polymers segments to tailor the properties of the targeted polymeric materials. The aromatic diamine monomers may include, but not limited to, any of the structures listed in FIG. 8.

As described herein, the synthetic methodology allows the preparation of a large variety of new polymers, including but not limited to, homopolymers, random copolymers, block copolymers, terpolymers, and so on. The polymers formed are used to prepare polymeric membranes with improved sweet or sour mixed-gas separations properties for natural gas purification application. The term sour means that the gas stream contains hydrogen sulfide (H₂S), where membranes are prone to plasticization due to the high affinity of H₂S molecules to polymeric materials due to the polar nature of H2S molecules. The changes can be implemented at every stage of the preparation of the polymer.

### Examples

Materials

All materials listed in this work were used as received. Aniline (ACS reagent, ≥99.5%), sodium sulfite anhydrous (purity 98.0%), and toluene (ACS reagent, 99.5%) were purchased from Sigma-Aldrich, USA. 4,4′-(hexa-fluoroisopropylidene)diphthalic anhydride (6FDA, purity 99.0%), and m-cresol (purity 99.0%) were acquired from Alfa Aesar. 2,3,5,6-tetramethylbenzene-1,4-diamine (Durene; purity 98.0%), and 2,7-dibromo-9H-fluoren-9-one (purity >98.0%) were obtained from TCI America. Methanol (purity 98.0%), ethyl acetate (reagent grade), and N,N-dimethylacetamide (DMAc, reagent grade) were purchased from Fisher Scientific. Sodium hydroxide (purity ≥98.0%), and 2-propanol (purity ≥99.9%) were acquired from Fluka.

Characterization Techniques

Proton Nuclear Magnetic Resonance Spectroscopy (¹H-NMR) The ¹H-NMR spectra of the prepared polymers and monomers were recorded using a JEOL 500 MHz NMR spectrometer in deuterated chloroform (CHCl₃-d) or dimethyl sulfoxide (DMSO-d₆) accordingly.

Fourier Transform Infra-Red Spectroscopy (FTIR)

The Fourier Transform Infrared (FTIR) spectra were recorded using a Thermo Scientific Nicolet iS50 spectrometer in transmission mode. Samples could be of the form of powder solid or membrane.

Thermogravimetric Analysis (TGA) and Glass Transition Temperature (T_{g})

The thermogravimetric analysis (TGA) plots and the differential scanning calorimetry (DSC) traces were performed using a NETZSCH STA 449 F3 Jupiter®. The TGA plots were recorded at a temperature range from 30° C. to 650° C. with a heating rate of 10° C./min under a nitrogen atmosphere. The glass transition temperature (T_{g}) was determined from the DSC traces over two consecutive cycles. Each cycle consists of heating the sample at a temperature range between 30° C. and 450° C., using a heating rate of 10° C./min under a nitrogen flow. The first run is aimed to clear the thermal history of the sample, and the T_{g} values were determined after the second cycle.

Syntheses of Monomers and Polymers

### Example 1: Synthesis of 4,4′-(2,7-dibromo-9H-fluorene-9,9-diyl)dianiline [CARDO(Br)]

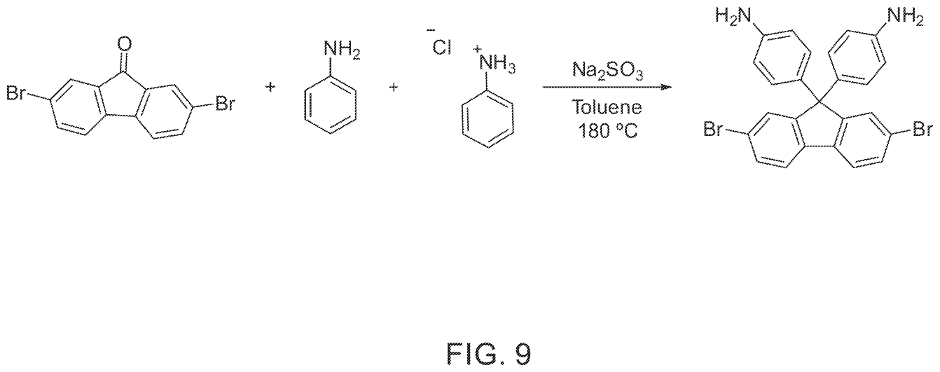

FIG. 9 is a synthetic scheme for forming the 4,4′-(2,7-dibromo-9H-fluorene-9,9-diyl)dianiline [CARDO(Br)] according to Example 1. In a 250-mL three-neck round bottom flask equipped with a nitrogen inlet, Dean-Stark apparatus, condenser, and a magnetic bar, 2,7-dibromo-9H-fluoren-9-one (5.00 g, 14.79 mmol), aniline (10.78 ml, 118 mmol), benzenaminium chloride (6.71 g, 51.8 mmol), and sodium sulfite (0.037 g, 0.296 mmol) were charged in the flask, followed by toluene (60 ml). The reaction mixture was heated to 100° C. to remove water from the reaction, then the temperature was increased to 150° C. and heating continued for 6 hours were most of the toluene was removed and collected in the Dean-Stark apparatus. During this time, the reaction color changes from yellow-orange to purple.

The reaction mixture was cooled down to 90° C., and the purple solid was treated with 10% sodium hydroxide until the pH was 14 then cooled down to 70° C. The stirring continued for 0.5 hour, then ethyl acetate was added and the organic layer was separated and washed with saturated sodium chloride, dried over MgSO₄, filtered and evaporate to give the crude product as a purple solid. To purify the product, 50 mL of toluene and 5 mL of isopropanol are added for every 1 g of the crude product, and heat to reflux until the crude product is completely dissolved, then after cooling to 20° C., crystals form in the flask. After filtration, the solid phase was collected, and the solid phase was vacuum dried at 70° C. for 6 hours to afford the pure product 4,4′-(2,7-dibromo-9H-fluorene-9,9-diyl)dianiline (6.89 g, 13.61 mmol, 92% yield) as white solid. H NMR (500 MHz, DMSO-d6) δ 7.85 (d, J=8.1 Hz, 2H), 7.60-7.51 (dd, J₁=8.5 Hz, J₂=1.5 Hz, 2H), 7.42 (d, J=1.9 Hz, 2H), 6.73 (d, J=8.5 Hz, 4H), 6.44 (d, J=8.5 Hz, 4H), 5.01 (s, 4H).

### Example 2: Synthesis of Homopolymer 6FDA-CARDO(Br)

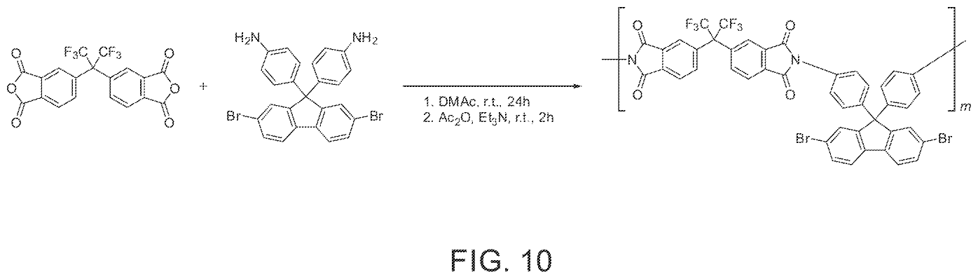

FIG. 10 is a synthetic scheme for forming the homopolymer 6FDA-CARDO(Br) according to Example 2. In a 100-ml three-neck round bottom flask equipped with a nitrogen inlet and a magnetic stir bar, 4,4′-(2,7-dibromo-9H-fluorene-9,9-diyl)dianiline [CARDO(Br), 0.600 g, 1.185 mmol] and 5,5′-(perfluoropropane-2,2-diyl)bis(isobenzofuran-1,3-dione) (6FDA, 0.527 g, 1.185 mmol) were dissolved in N,N-Dimethylacetamide (DMAc, 6.00 ml). The colorless mixture was stirred at room temperature (r.t.) for 24 hours. Subsequently, acetic anhydride (0.448 ml, 4.74 mmol) and triethylamine (0.165 ml, 1.185 mmol) were added slowly into the above solution, and the chemical imidization reaction was performed under nitrogen atmosphere at r.t. for 2 hours. The reaction solution was light yellow and remained viscous. The FTIR spectrum of an aliquot sample showed the complete conversion of polyamic acid into polyimide. The resulting viscous solution was poured into a Petri dish, the flask was washed with additional 10 mL of DMAc, and placed in an oven preheated at 90° C. under a gentle nitrogen flow. The final product 6FDA-CARDO(Br) (1.119 g, 1.185 mmol, 100% yield) was then dried under reduced pressure at 200° C. for two days. ¹H NMR (500 MHz, Chloroform-d) δ 8.03 (d, J=7.7 Hz, 2H), 7.95 (s, 2H), 7.85 (d, J=7.2 Hz, 2H), 7.62 (d, J=7.7 Hz, 2H), 7.56-7.50 (m, 4H), 7.35 (q, J=7.9 Hz, 8H).

### Example 3: Synthesis of (1:1) Block Copolyimide 6FDA-Durene/6FDA-CARDO(Br)

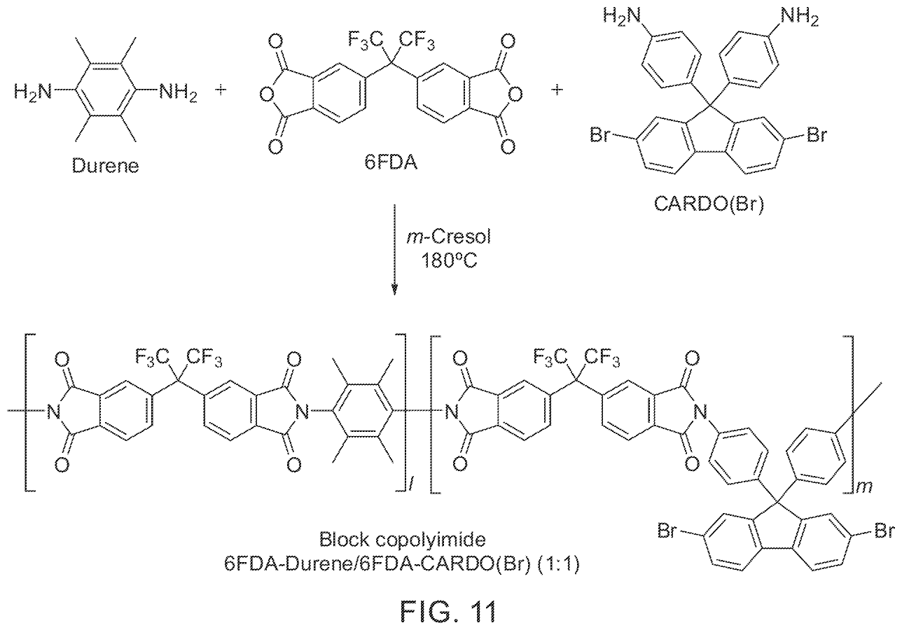

FIG. 11 is a synthetic scheme for forming the (1:1) block copolyimide 6FDA-Durene/6FDA-CARDO(Br) according to Example 3. In a 100-ml three-neck round bottom flask equipped with a nitrogen inlet and a magnetic bar, 5,5′-(perfluoropropane-2,2-diyl)bis(isobenzofuran-1,3-dione) (0.406 g, 0.913 mmol) (6FDA), 2,3,5,6-tetramethylbenzene-1,4-diamine (0.150 g, 0.913 mmol) (Durene) were introduced and dissolved in m-cresol (4.6 ml) and the reaction mixture was heated to 180° C., and the mixture was stirred for 8 hours, then cooled down to room temperature. The reaction mixture was preheated to 160° C., then 5,5′-(perfluoropropane-2,2-diyl)bis(isobenzofuran-1,3-dione) (0.406 g, 0.913 mmol) (6FDA), and 4,4′-(2,7-dibromo-9H-fluorene-9,9-diyl)dianiline (0.462 g, 0.913 mmol) [CARDO(Br)], followed by m-cresol (4.60 ml) and the mixture was heated to 180° C. and stirred for 8 hours. The heat was removed and the reaction mixture was allowed to cool down below 100° C., then the resulting highly viscous solution was poured into water and precipitated. The solid polymer obtained was rinsed four times with methanol (100 mL), filtered and dried under reduced pressure for 24 h at 60° C. to afford 6FDA-Durene/6FDA-CARDO(Br) (1:1) (1.357 g, 0.895 mmol, 98% yield) as a white off powder. ¹H NMR (500 MHz, CDCl₃) δ 8.12-7.90 (m, 10H), 7.85 (d, J=7.4 Hz, 2H), 7.62 (d, J=7.7 Hz, 2H), 7.56-7.49 (m, 4H), 7.35 (q, J=7.8 Hz, 8H), 2.14 (s, 12H).

### Example 4: Synthesis of (2:1) Block Copolyimide 6FDA-Durene/6FDA-CARDO(Br)

The procedure of Example 3 was repeated using 5,5′-(perfluoropropane-2,2-diyl)bis(isobenzofuran-1,3-dione) (0.676 g, 1.522 mmol) (6FDA), 2,3,5,6-tetramethylbenzene-1,4-diamine (0.250 g, 1.522 mmol) (Durene), m-cresol (8.00 ml), then 5,5′-(perfluoropropane-2,2-diyl)bis(isobenzofuran-1,3-dione) (0.338 g, 0.761 mmol) (6FDA), and 4,4′-(2,7-dibromo-9H-fluorene-9,9-diyl)dianiline (0.385 g, 0.761 mmol) [CARDO(Br)], followed by m-cresol (8.00 ml) to afford 6FDA-Durene/6FDA-CARDO(Br) (2:1) (2.263 g, 1.492 mmol, 98% yield) as a white off powder. ¹H NMR (500 MHz, DMSO-d6) δ 8.23-7.88 (m, 18H), 7.78 (s, 2H), 7.74 (s, 2H), 7.65 (d, J=7.4 Hz, 2H), 7.43 (d, J=7.5 Hz, 4H), 7.34 (d, J=7.0 Hz, 4H), 2.09 (s, 24H).

### Example 5: Synthesis of (3:1) Block Copolyimide 6FDA-Durene/6FDA-CARDO(Br)

The procedure of Example 3 was repeated using 5,5′-(perfluoropropane-2,2-diyl)bis(isobenzofuran-1,3-dione) (0.676 g, 1.522 mmol) (6FDA), 2,3,5,6-tetramethylbenzene-1,4-diamine (0.250 g, 1.522 mmol) (Durene) in m-cresol (4.6 ml), then 5,5′-(perfluoropropane-2,2-diyl)bis(isobenzofuran-1,3-dione) (0.225 g, 0.507 mmol) (6FDA), and 4,4′-(2,7-dibromo-9H-fluorene-9,9-diyl)dianiline (0.257 g, 0.507 mmol) [CARDO(Br)], followed by m-cresol (4.60 ml) to afford 6FDA-Durene/6FDA-CARDO(Br) (3:1) (2.263 g, 1.492 mmol, 98% yield) as a white off powder. ¹H NMR (500 MHz, Chloroform-d) δ 8.12-7.81 (m, 24H), 7.62 (d, J=8.0 Hz, 2H), 7.57-7.48 (m, 4H), 7.35 (q, J=7.8 Hz, 8H), 2.14 (s, 36H).

### Example 6: Preparation of the Block Copolyimide 6FDA-DAM/6FDA-CARDO(Br) (3:1)

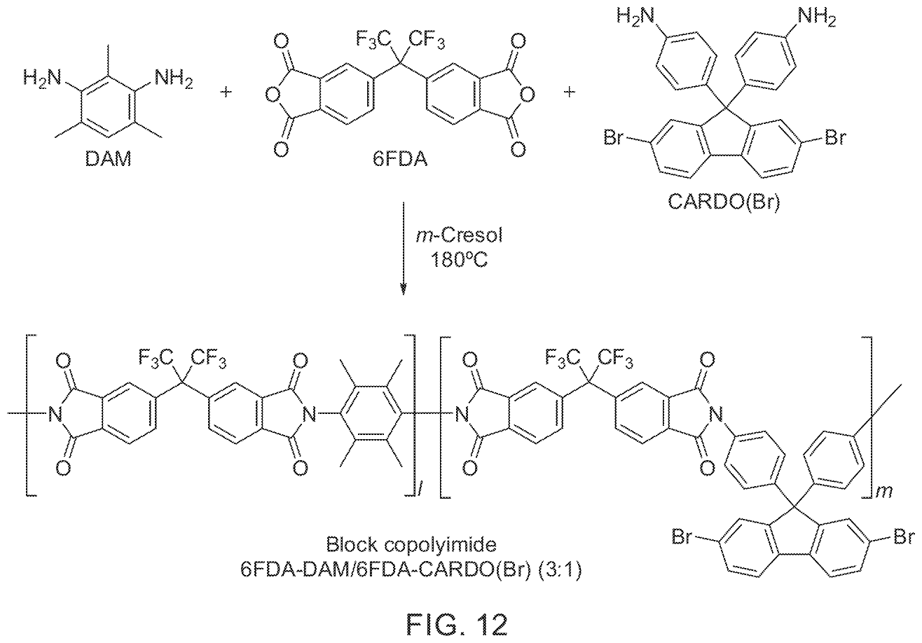

FIG. 12 is a synthetic scheme for forming the (1:1) block copolyimide 6FDA-Durene/6FDA-CARDO(Br) according to Example 6. In a 100-ml three-neck round bottom flask equipped with a nitrogen inlet and a magnetic bar, 5,5′-(perfluoropropane-2,2-diyl)bis(isobenzofuran-1,3-dione) (0.739 g, 1.664 mmol) (6FDA), 2,4,6-trimethylbenzene-1,3-diamine (0.250 g, 1.664 mmol) (DAM) were introduced and dissolved in m-cresol (8.00 ml). The reaction mixture was heated to 180° C., and the mixture was stirred for 8 hours, then cooled down to room temperature. The reaction mixture was then preheated to 160° C., then 5,5′-(perfluoropropane-2,2-diyl)bis(isobenzofuran-1,3-dione) (0.225 g, 0.507 mmol) (6FDA), and 4,4′-(2,7-dibromo-9H-fluorene-9,9-diyl)dianiline (0.257 g, 0.507 mmol) [CARDO(Br)], followed by m-cresol (8.00 ml) and the mixture was heated to 180° C. and stirred for 8 hours. The heat was removed and the reaction mixture was allowed to cool down below 100° C., then the resulting highly viscous solution was poured into water in thin fibers. The solid polymer obtained was rinsed four times with methanol (100 mL), filtered and dried under reduced pressure for 24 h at 60° C. to afford 6FDA-DAM/6FDA-CARDO(Br) (3:1) (2.242 g, 1.492 mmol, 98% yield) as a white off powder. ¹H NMR (500 MHz, Chloroform-d) δ 8.08-7.82 (m, 24H), 7.62 (d, J=7.2 Hz, 2H), 7.57-7.50 (m, 4H), 7.35 (q, J=8.1 Hz, 8H), 7.24 (s, 3H), 2.21 (s, 18H), 1.98 (s, 9H).

Chemical Characterization

The various chemical structures of the compounds prepared in this disclosure were confirmed using ¹H NMR in deuterated solvents. Examples of the spectra for these compounds are illustrated below. Further confirmation was provided by the results from FTIR analysis.

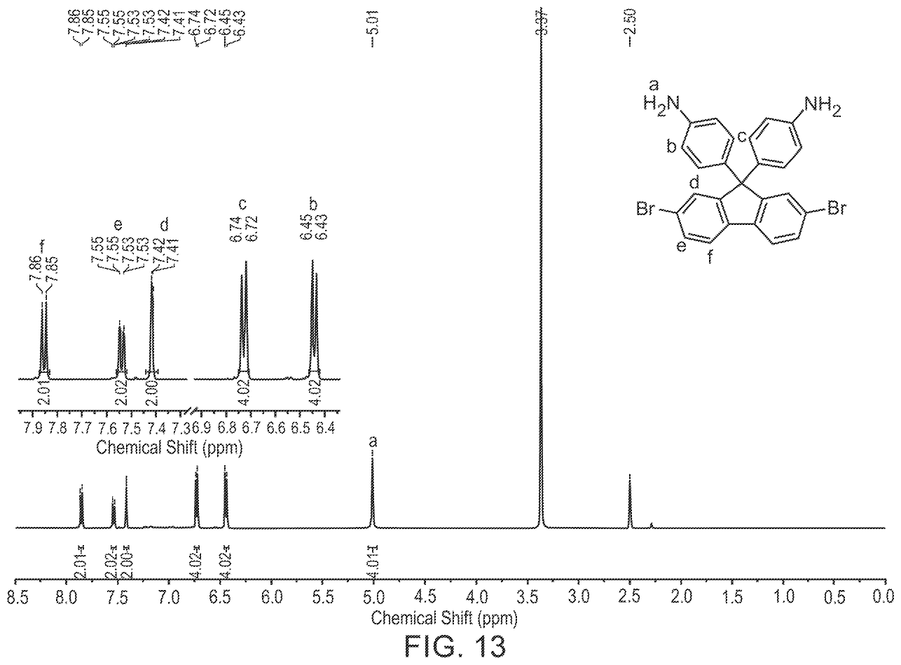

FIG. 13 is a ¹H NMR spectrum of 4,4′-(2,7-dibromo-9H-fluorene-9,9-diyl)dianiline [CARDO(Br)] in DMSO-d6. The chemical structure of the CARDO(Br) monomer was confirmed by its ¹H-NMR spectrum in deuterated DMSO-d₆ as illustrated in FIG. 13. The spectrum depicts the different aromatic protons that range between 7.86-6.43 ppm, in addition to the primary amine protons represented as a singlet peak at 5.01 ppm. The absence of any other peaks in the spectrum (other than those from the deuterated solvent: H₂O at 3.37 ppm, and DMSO at 2.50 ppm) indicate the high purity of the prepared monomer.

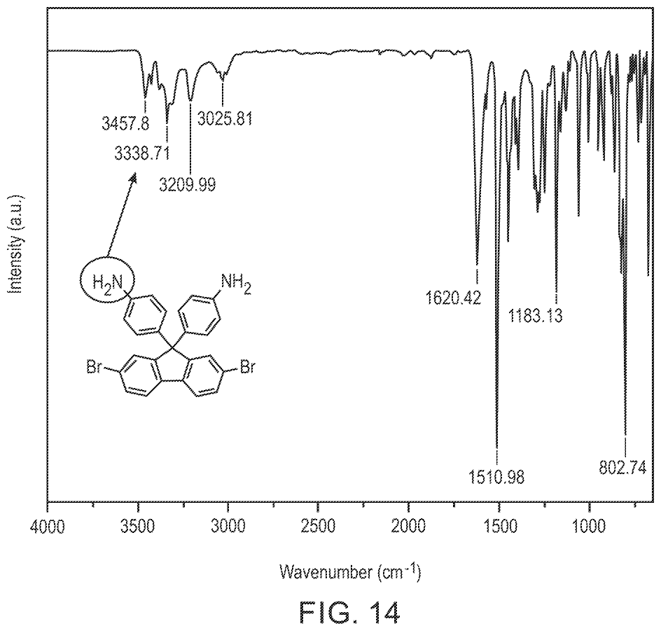

FIG. 14 is an FTIR spectrum of CARDO(Br) monomer. The presence of functional groups within the structure of CARDO(Br) monomer, such as the primary amine groups, were confirmed using Fourier transform infrared (FTIR) spectroscopy, and the spectrum is illustrated in FIG. 14. For example, the primary amine stretching bands (N—H) are depicted between 3460 and 3200 cm⁻¹, while the peak at 1620 cm⁻¹ can be assigned to the primary amine N—H bending. Moreover, the peak at 1511 cm⁻¹ is attributed to the aromatic carbon-hydrogen bond (sp² C—H) bending.

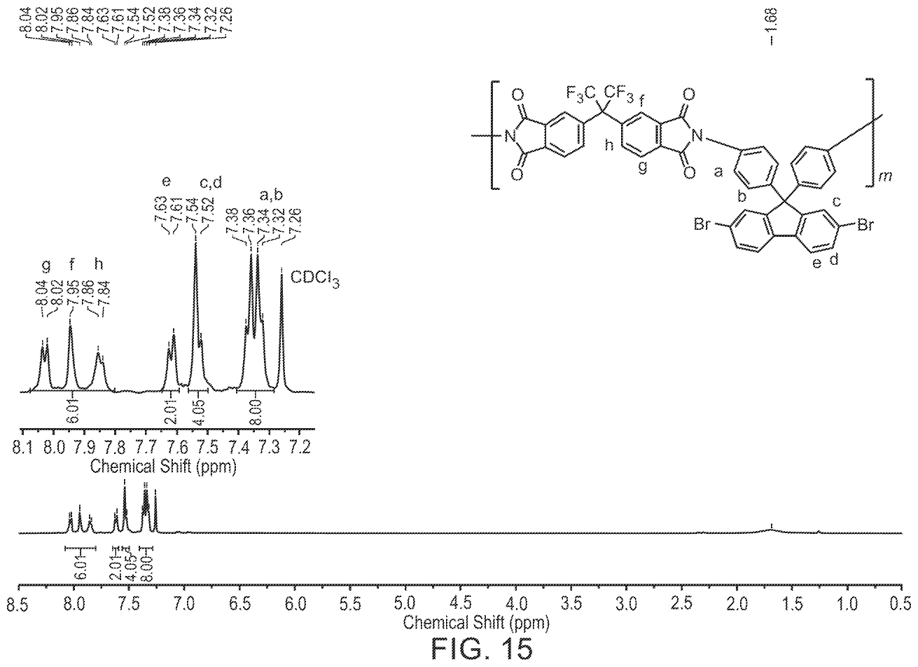

FIG. 15 is a ¹H NMR spectrum of 6FDA-CARDO(Br) homopolymer in CDCl₃. In a similar fashion, the chemical structures and purity of the final product of the polymers described in this invention were confirmed using ¹H-NMR in CDCl₃ or DMSO-d₆. The peaks at 8.03 ppm (doublet), 7.95 ppm (singlet), and 7.85 ppm (doublet) from the spectrum are attributed to the aromatic protons of 6FDA moiety, while the remaining peaks at 7.6 3 ppm (doublet), 7.54-7.52 ppm (multiplet), and the AB system between 7.38-7.32 ppm are attributed to the CARDO(Br) aromatic protons. The absence of any undesired peak within the spectrum is an indication to the good purity of the prepared polymer.

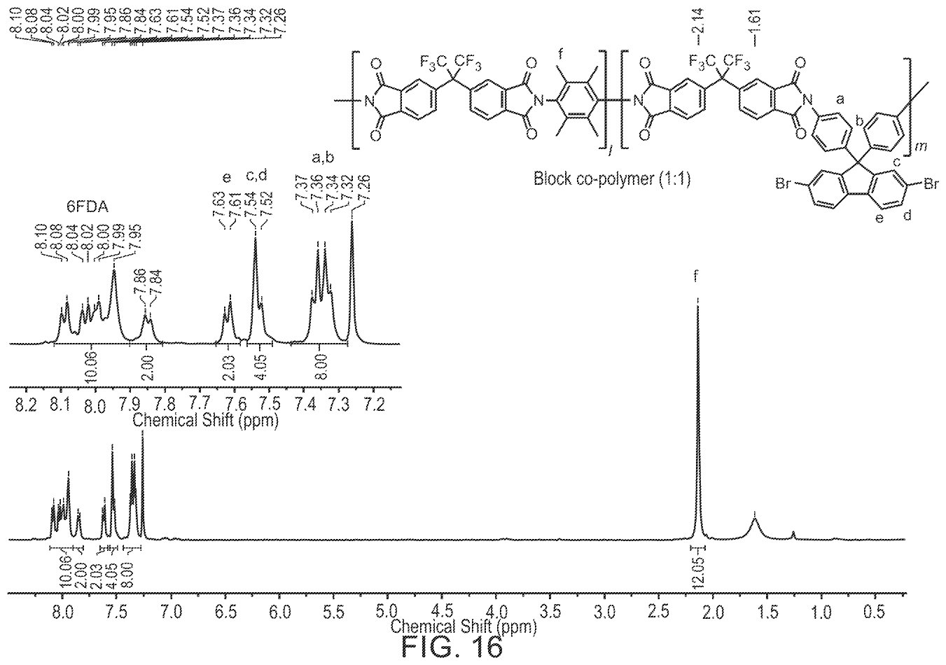

FIG. 16 is a ¹H NMR spectrum of 6FDA-Durene/6FDA-CARDO(Br) (1:1) copolymer in CDCl₃. For copolyimides, in addition to determining their chemical structures and purities, the ¹H-NMR spectra are further used to determine the molecular ratio of the comonomers within the copolymer backbone. For example, the desired molar ratio between the durene and CARDO(Br) monomers in the 6FDA-Durene/6FDA-CARDO(Br) (1:1) block copolymer described in Example 3 is calculated from the ratio of the integrated peak areas of the aromatic and aliphatic regions of durene and CARDO(Br), respectively. For instance, the durene monomer does not have aromatic protons. However, it possesses 12 aliphatic protons that correspond to its four-methyl groups depicted by the singlet peak at 2.14 ppm. The total integration of the aromatic peaks that correspond to CARDO(Br) show a total of 14 protons that indicate a molar ratio of 1:1 between durene and CARDO(Br) comonomers. In a similar way, the molar ratios between durene and CARDO(Br) comonomers in 6FDA-Durene/6FDA-CARDO(Br) (2:1) and 6FDA-Durene/6FDA-CARDO(Br) (3:1) block copolymers (Examples 4 and 5), and DAM and CARDO(Br) in 6FDA-DAM/6FDA-CARDO(Br) (3:1) block copolymer (Example 6) where determined using their corresponding ¹H NMR spectra.

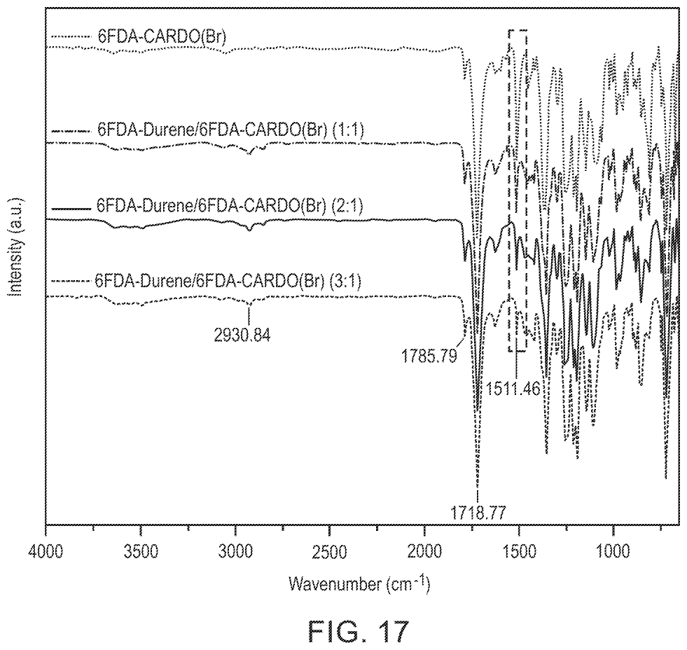

FIG. 17 is a plot of normalized FTIR spectra of 6FDA-CARDO(Br) homopolyimide and a series of 6FDA-Durene/6FDA-CARDO(Br) copolyimides at different composition ratios (x:1) (the present polymers). The FTIR spectra of all the described polymers in this invention were recorded to ensure that the polycondensation reaction went to completion during the polymer's preparation. In general, the absence of any peaks that correspond to the intermediate species, such as the polyamic acid (3500-3100 and 1700-1650 cm⁻¹), demonstrates that the reaction is complete. Further, the symmetric and asymmetric carbonyl groups of the imide ring depicted at 1785 and 1718 cm⁻¹, respectively, confirm the formation of the imide ring (final product) within the polymer backbone.

The FTIR spectra can also be used to qualitatively determine the molecular ratio of comonomers within the copolymer backbone. For example, the peak at 1511 cm⁻¹ is attributed to the aromatic carbon-hydrogen bond (sp² C—H) bending that mainly belongs to those of CARDO(Br) monomer, as can be seen from the FTIR spectrum of 6FDA-CARDO(Br) illustrated in FIG. 17. However, in the FTIR spectra of copolyimides, it can be noted that the intensity of the peak at 1511 cm⁻¹ decreases with the decrease of the CARDO(Br) molar ratio compared to durene [i.e., Durene: CARDO(Br) from 0.50 absorbance units (a.u.) (1:1) to 0.25 a.u. (3:1)]. Finally, the appearance of the peaks at around 2930 cm⁻¹ in the FTIR spectra of the three copolyimides are attributed to the aliphatic C—H bonds of the methyl groups in Durene, which are not existent in the FTIR spectrum of the homopolymer 6FDA-CARDO(Br).

Thermal Properties

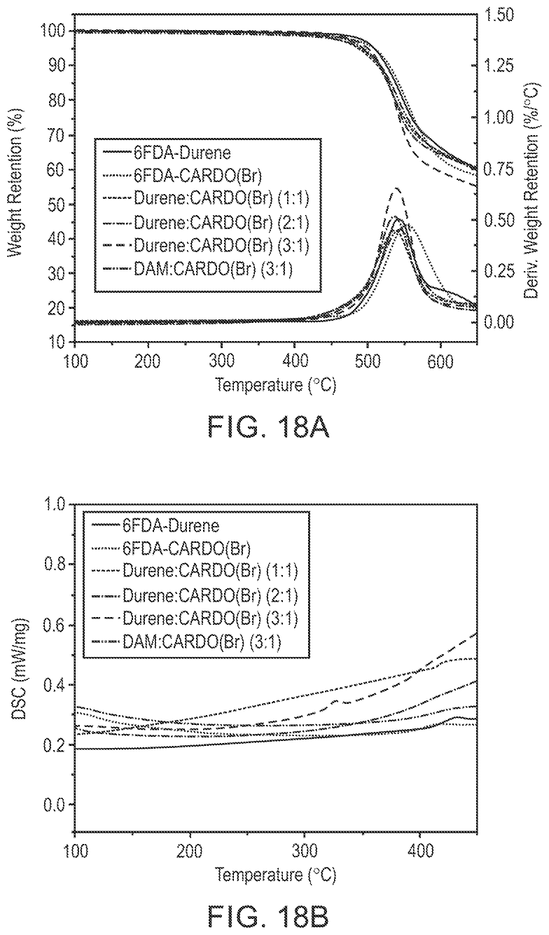

FIG. 18A is a plot of the thermogravimetric analysis (TGA) curves and the first derivative curves (DTG) of the prepared polymers. The decomposition temperatures at 5% and 10% were determined (Table 1) to evaluate the thermal stability of the prepared polymers during the harsh industrial conditions of gas separation application. All T_{d5%} of the prepared polymers found to be higher than 490° C., which is similar to other highly stable membranes used in gas separation technology. The first derivatives of the TGA curves were calculated and the values are listed in Table 1. These values (>510° C.) indicate the highest temperature at which the polymer degrades the fastest, are additional indication to the high thermal stability of the prepared polymers.

TABLE 1
Thermal properties of the prepared polymers in this invention.

| | DSC | TGA | | |
|---|---|---|---|---|
| | T_{g} | T_{d5%} | T_{d10%} | DTG |
| | (° C.) | (° C.) | (° C.) | (° C.) |
| 6FDA-Durene | 426 | 510 | 527 | 542 |
| 6FDA-DAM | 395 | 516 | 530 | 545 |
| 6FDA-CARDO(Br) | 407 | 508 | 530 | 555 |
| 6FDA-Durene/6FDA- | 409 | 490 | 513 | 537 |
| CARDO(Br) (1:1) | | | | |
| 6FDA-Durene/6FDA- | 402 | 495 | 517 | 539 |
| CARDO(Br) (2:1) | | | | |
| 6FDA-Durene/6FDA- | 395 | 501 | 519 | 541 |
| CARDO(Br) (3:1) | | | | |
| 6FDA-DAM/6FDA- | 413 | 490 | 517 | 542 |
| CARDO(Br) (3:1) | | | | |

FIG. 18B is a plot of the differential scanning calorimetric (DSC) curves for the prepared polymers. The glass transition temperatures (T_{g}) of the prepared polymers were calculated from their corresponding DSC traces and the values are listed in Table 1. To obtain the T_{g} values, polymer samples were heated for two cycles. The first heating cycle was used to clear the thermal history of the polymer, where the T_{g} was recorded after the second heating cycle. All the recorded T_{g} values were greater than 395° C. These high temperatures indicate the rigidity of the polymeric chains, which is correlated to their performance during gas separation testing. The values obtained are similar to other glassy polymers used in gas separation technology.

Density and Fractional Free Volume

The fractional free volume (FFV) values of membranes prepared from the studied polymers were calculated using the following equation:

$$FFV = \frac{V - {V}_{0}}{V} \qquad ( 1 )$$

where V is the specific volume and V₀ is the occupied volume by the polymer. Note that V is the reciprocal of the polymer density and can be determined experimentally. The densities of the prepared polymers were measured using a Mettler Toledo XPE205 balance equipped with a density kit using cyclohexane (d=0.777 g/cm³) as the buoyant liquid at 20° C. The density values reported in Table 2 are the average values of at least five different measurements, with error values (standard deviation) below 5%. The occupied volume (V₀) values were calculated from the van der Waals volumes (V_{w}) using Bondi's equation:

V₀=1.3×V_{w} (2)

The van der Waals volumes of copolymers were calculated from the individual V_{w} of the constituent homopolymers taking into consideration their different molar ratios in the copolymer backbone using the following equation:

V_{w}=X₁V_{w}_{₁}+X₂V_{w}_{₂}, (3)

where X₁ and X₂ are the molar ratios, and V_{w}_{₁} and V_{w}_{₂} are the van der Waals volumes of the constituent homopolymers. In our case, we have estimated the van der Waals volumes using a web simulation tool rather than the Bondi's group contribution method due to missing volume values within the functional groups reported.

TABLE 2
Density and fractional free volume (FFV)
values of the prepared polymers.

| | V₀ | V | d | |
|---|---|---|---|---|
| Sample | (cm³/g) | (cm³/g) | (g/cm³) | FFV |
| 6FDA-Durene | 0.6123 | 0.7735 | 1.2929 | 0.2083 |
| 6FDA-DAM | 0.6038 | 0.7569 | 1.3212 | 0.2023 |
| 6FDA-CARDO(Br) | 0.5438 | 0.6738 | 1.4840 | 0.1930 |
| 6FDA-Durene/6FDA- | 0.5780 | 0.7187 | 1.4091 | 0.1855 |
| CARDO(Br) (1:1) | | | | |
| 6FDA-Durene/6FDA- | 0.5895 | 0.7280 | 1.3735 | 0.1903 |
| CARDO(Br) (2:1) | | | | |
| 6FDA-Durene/6FDA- | 0.5952 | 0.7469 | 1.3388 | 0.2032 |
| CARDO(Br) (3:1) | | | | |
| 6FDA-DAM/6FDA- | 0.5888 | 0.7282 | 1.3732 | 0.1915 |
| CARDO(Br) (3:1) | | | | |

For the durene:CARDO(Br) block copolymer series, the FFV increased with the increase of the molar ratio of durene in the copolymer backbone. For example, the FFV increased from 0.1855 for a durene:CARDO(Br) ratio of 1:1, to 0.2032 for a durene:CARDO(Br) ratio of 3:1. These results correlate to the gas permeation results in the next section.

Membrane Performance Test

Membrane Fabrication

The polymeric membranes were prepared using a solution casting method. Solutions with concentration of 3 wt. % polymer in N,N-dimethylformamide (DMF) were prepared. Then, 11 mL of the solution were filtered through a 0.45 μm PTFE filter to remove any possible solid impurities and poured into a leveled 5.5 cm diameter flat glass Petri dish. The casting dish was placed in a preheated oven at 85° C., under a gentle flow of nitrogen to allow a slow evaporation of the solvent. After 24 hours, the obtained membrane was further dried at 200° C. under vacuum for another 24 hours. The membrane was peeled off from the Petri dish by soaking in deionized water for a few minutes before peeling from the Petri dish. The membranes were then dried at 60° C. under vacuum for 6 hours. The thickness of the prepared membranes was determined to be in the range of 60-120 μm. For an individual membrane, the standard deviation of thickness uniformity was less than 3%. The formed membrane was cut using a 4 cm diameter cutter, to fit into the membrane cell of the gas permeation testing system.

Permeation Measurements

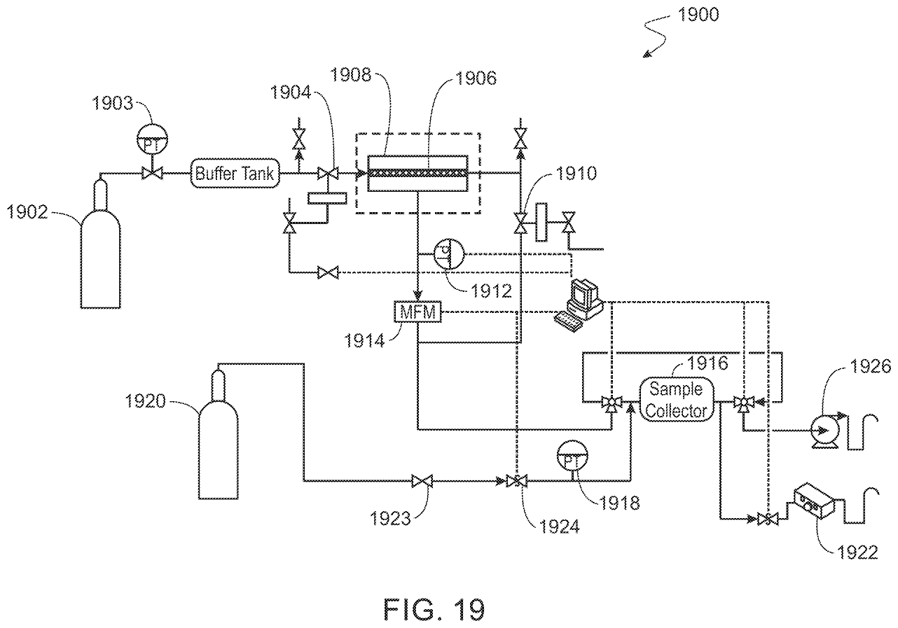

FIG. 19 is a simplified process flow diagram of a continuous-flow gas permeation device 1900 used for measuring single gas and mixed gas permeation properties. A test gas cylinder 1902 provides a single gas or gas mixture for testing. A pressure transducer 1903 measures the gas pressure from the test gas cylinder 1902. An actuated valve 1904 allows the test gas to flow through or pressurize the interior of a sample membrane 1906 that is surrounded by a chamber 1908. A second actuated valve 1910 allows retentate samples to be taken from the inside of the sample membrane 1906 as opposed to permeate samples from the chamber 1908. A pressure transducer 1912 measures the pressure of the permeate in the chamber 1908.

A mass flow meter 1914 measures the amount of permeate exiting the chamber 1908. A sample collector 1916 can be used to collect samples of permeate or retentate for analysis. A pressure transducer 1918 is used to measure the pressure of gas in the sample collector 1916. A carrier gas cylinder 1920 provides a carrier gas, such as helium, for a gas chromatograph 1922. The flow rate of the carrier gas is set by a needle valve 1923. After collection of a gas sample in the sample collector 1916, other valves are closed, and an actuated valve 1924 is opened to sweep the sample to the gas chromatograph 1922. A vacuum pump 1926 is used to pull a vacuum on the system before and between test runs.

Pure-Gas Permeation Measurement

The pure-gas permeation properties of the prepared polymeric membranes were measured using an in-house built constant volume/variable pressure permeation system. The membrane was placed in the permeation cell and subjected to a selected gas feed (i.e., He, N₂, CH₄ and CO₂) for a specific time, to reach a permeation steady-state at a constant feed pressure of 100 psi and a temperature 22° C. The permeability coefficients (P) were calculated from the slope

$${( \frac{{dp}_{p}}{dt} )}_{ss}$$

the steady state (ss) of the permeate pressure (pₚ) versus time curve using the following equation:

$$P = {10}^{10} \frac{{V}_{d} l}{{p}_{f} ART} [ {( \frac{{dp}_{p}}{dt} )}_{ss} - {( \frac{{dp}_{p}}{dt} )}_{leak} ] \qquad ( 4 )$$

where, V_{d} is the permeate tube volume (cm³), I is the membrane thickness (cm), p_{f} is the gas feed pressure (cmHg), A is the membrane effective surface area (cm²), R is the universal gas constant (R=0.278 cm³·cmHg/cm³(STP)·K), T is the operational temperature (K),

$${( \frac{{dp}_{p}}{dt} )}_{ss}$$

is the steady-state pressure variation in the permeate tube (cmHg), and

$${( \frac{{dp}_{p}}{dt} )}_{leak}$$

is the leak rate of the system, which is usually very small and may be neglected. The permeability coefficient is expressed in Barrer, where 1 Barrer=10⁻¹⁰ cm³(STP)·cm/cm²·s·cmHg.

The ideal selectivity coefficient for two selected gases A and B is calculated from the ratio of their corresponding permeabilities (PA and P_{B}) using the following expression:

$${∝}_{A / B} = \frac{{P}_{A}}{{P}_{B}} \qquad ( 5 )$$

The diffusivity coefficients D (cm²/s) of the gas penetrants were calculated by the time-lag method using the following expression:

$$D = \frac{{l}^{2}}{6 θ} \qquad ( 6 )$$

where θ(s) is the time-lag determined from the pure-gas permeability measurement, and l (cm) in the membrane thickness. The solubility coefficient S (cm³(STP)/cm³·cmHg·) can be then calculated from the permeability and diffusivity coefficients using the following equation:

$$S = \frac{P}{D} \qquad ( 7 )$$

Results of Permeation Tests

The pure-gas permeation properties of membranes prepared from the studied polymers were determined using the permeation system 1900 in a constant-volume mode. For this study, four different pure gases were used: He, N₂, CH₄, and CO₂. The polymeric membranes permeability and selectivity coefficients were calculated from the steady state of the pressure versus time curve, using a constant feed pressure of 100 psi and an operating temperature of 22° C. The obtained results are listed in Table 3. The permeability coefficients are listed in Barrer, where 1 Barrer=10⁻¹⁰ cm³ (STP) cm/cm²·s·cmHg.

TABLE 3
Pure gas permeability and selectivity coefficients for the polymeric
membranes measured at 100 psi feed pressure and at 22° C.

| | Permeability coefficients (Barrer) | | | | Selectivity coefficients | | |
|---|---|---|---|---|---|---|---|
| Polyimide | He | N₂ | CH₄ | CO₂ | He/CH₄ | N₂/CH₄ | CO₂/CH₄ |
| 6FDA-Durene | 451 | 55.9 | 46.1 | 740 | 9.77 | 1.21 | 16.0 |
| 6FDA-DAM | 332 | 35.0 | 24.3 | 541 | 13.7 | 1.44 | 22.3 |
| 6FDA-CARDO | 85.0 | 3.30 | 1.96 | 58.9 | 43.4 | 1.68 | 30.1 |
| 6FDA-CARDO(Br) | 93.7 | 3.69 | 2.89 | 79.6 | 32.4 | 1.28 | 27.5 |
| 6FDA-Durene/6FDA-CARDO(Br) (1:1) | 207 | 13.0 | 9.41 | 231 | 22.0 | 1.40 | 24.5 |
| 6FDA-Durene/6FDA-CARDO(Br) (2:1) | 275 | 19.5 | 14.9 | 341 | 18.4 | 1.30 | 22.8 |
| 6FDA-Durene/6FDA-CARDO(Br) (3:1) | 334 | 27.0 | 20.6 | 431 | 16.2 | 1.30 | 21.0 |
| 6FDA-DAM/6FDA-CARDO(Br) (3:1) | 323 | 24.9 | 18.5 | 378 | 17.5 | 1.35 | 20.5 |

The pure-gas permeation properties of 6FDA-CARDO(Br) homopolyimide show a moderate CO₂ permeability of 80 Barrer and a relatively high CO₂/CH₄ selectivity of 27.5. These results are considered attractive to use the 6FDA-CARDO(Br) as a selectivity-enhancing segment in future copolymers. By comparing the gas permeation properties of 6FDA-CARDO(Br) to that of 6FDA-CARDO, we observe that the CO₂ permeability increased by ˜35% in the case of 6FDA-CARDO(Br), while the CO₂/CH₄ selectivity dropped by only ˜9% due to the known permeability-selectivity trade-off for glassy polymers. These results demonstrate the benefit of adding halogen atoms to the 2 and 7 positions of the fluorenyl group of the CARDO moiety.

Further improvements can be gained by copolymerization. For example, copolymerization can be used employed to improve the mechanical properties of membranes, and their gas permeation properties, through the selection of comonomers that possess desired properties. Durene (2,3,5,6-tetramethylbenzene-1,4-diamine) and DAM (2,4,6-trimethylbenzene-1,3-diamine) are two potential comonomers known for forming membranes with good mechanical and gas permeation properties. Thus, a series of copolyimides containing durene:CARDO(Br) with various molar ratios 1:1, 2:1, and 3:1, and a DAM:CARDO(Br) molar ratio of 3:1 were prepared. These copolyimides formed mechanically stabled membranes and their pure-gas permeation properties were measured and listed in Table 3.

The pure-gas permeation studies for the durene:CARDO(Br) pair showed an increase in the pure CO₂-permeability coefficients with an increasing molar ratio of the durene within the copolymer backbone. An increase in the FFV of the polymeric membrane matrix was also seen, as shown in the data of Table 2. For example, the pure CO₂-permeability increased from 231 Barrer for a 1:1 molar ratio (FFV=0.1855) to 341 Barrer for a 2:1 molar ratio (FFV=0.1903), and 431 Barrer for a 3:1 molar ratio (FFV=0.2032).

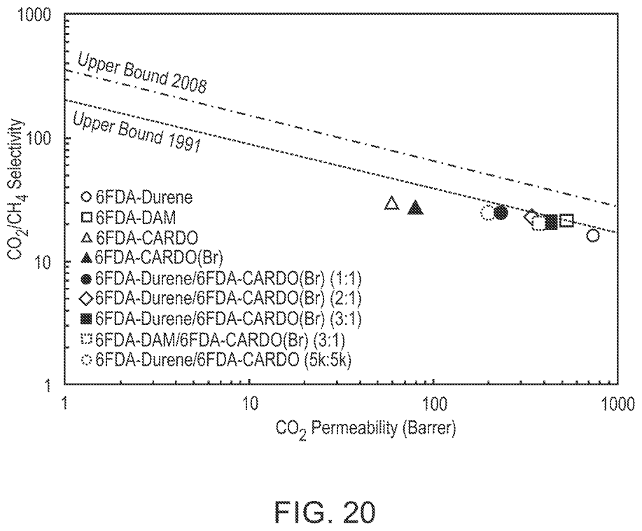

FIG. 20 is a plot comparing the CO₂/CH₄ permeability-selectivity “trade-off” curve of Robeson to the present polymers. In the early 1990s, a research survey determined that polymers with a high selectivity have a low permeability and that the opposite is also true, that materials with a low selectivity have a high permeability. This provides the plot line labeled as “Upper Bound 1991.” The research survey was updated to reflect advancements in membrane technology in an article in 2008, providing the plot line labeled “Upper Bound 2008.” See L. M. Robeson, “The Upper Bound Revisited,” Journal of Membrane Science 320, 390-400 (2008).

In general, membranes prepared from glassy polymers suffer from permeability-selectivity trade-off, as shown in FIG. 20. This is also observed for the membranes of the present techniques. The CO₂/CH₄ selectivity coefficients slightly decreased with the increase of durene molar ratio within the backbones of the copolymers. For example, the CO₂/CH₄ selectivity decreased from 24.5 for a 1:1 molar ratio to 22.8 for a 2:1 molar ratio, and 21.0 for a 3:1 molar ratio. However, the gas permeation properties of the series of 6FDA-durene/6FDA-CARDO(Br) membranes afforded permeability and selectivity coefficients in the desired potential commercially favored range.

In another example, replacing durene by DAM, with a DAM:CARDO(Br) equals to 3:1 to form the 6FDA-DAM/6FDA-CARDO(Br) (3:1) block copolyimide, afforded a membrane with slightly lower performance than the equivalent 6FDA-Durene/6FDA-CARDO(Br) (3:1). The pure CO₂-permeability decreased to 378 Barrer with a similar CO₂/CH₄ selectivity of 20.5.

To better understand the separation process of the prepared membranes, the CO₂ and CH₄ diffusivity coefficients (in cm²/s) were measured using the time-lag method. The obtained results are listed in Table 4.

TABLE 4
CO₂ and CH₄ diffusivity coefficients of
prepared polymers at 100 psi and 22° C.

| | Diffusivity | | Diffusivity |
|---|---|---|---|
| | (cm²/s) ×10⁻⁸ | | Selectivity |
| Polymer | CH₄ | CO₂ | CO₂/CH₄ |
| 6FDA-Durene | 7.24 | 33.3 | 4.60 |
| 6FDA-DAM | 4.98 | 25.3 | 5.08 |
| 6FDA-CARDO | 0.801 | 5.27 | 6.58 |
| 6FDA-CARDO(Br) | 3.49 | 5.05 | 1.45 |
| 6FDA-Durene/6FDA-CARDO(Br) (1:1) | 6.44 | 12.7 | 1.97 |
| 6FDA-Durene/6FDA-CARDO(Br) (2:1) | 8.70 | 16.5 | 1.90 |
| 6FDA-Durene/6FDA-CARDO(Br) (3:1) | 13.5 | 20.6 | 1.53 |
| 6FDA-DAM/6FDA-CARDO(Br) (3:1) | 12.9 | 17.4 | 1.35 |

As shown, the diffusivity coefficients for both CO₂ and CH₄ for the series of durene:CARDO(Br) copolyimides showed an increase with an increase in the molar ratio of durene within the copolymers backbones. Since the permeability coefficient (P) is calculated from the product of diffusivity (D) and solubility (S) coefficients, the solubility coefficients of the prepared polymers were calculated using equation (7). The obtained solubility coefficients [in cm³(STP)/cm³·cmHg] are listed in Table 5.

TABLE 5
CO₂ and CH₄ solubility coefficients of
prepared polymers at 100 psi and 22° C.

| | Solubility | | |
|---|---|---|---|
| | (cm³(STP)/ | | Solubility |
| | cm³cmHg) × 10⁻² | | Selectivity |
| Polymer | CH₄ | CO₂ | CO₂/CH₄ |
| 6FDA-Durene | 6.24 | 22.1 | 3.54 |
| 6FDA-DAM | 4.48 | 20.7 | 4.62 |
| 6FDA-CARDO | 2.45 | 11.2 | 4.52 |
| 6FDA-CARDO(Br) | 0.828 | 15.8 | 19.1 |
| 6FDA-Durene/6FDA-CARDO(Br) (1:1) | 1.46 | 18.2 | 12.5 |
| 6FDA-Durene/6FDA-CARDO(Br) (2:1) | 1.71 | 20.7 | 12.1 |
| 6FDA-Durene/6FDA-CARDO(Br) (3:1) | 1.68 | 20.9 | 12.4 |
| 6FDA-DAM/6FDA-CARDO(Br) (3:1) | 1.43 | 21.7 | 15.2 |

The solubility coefficients for both CO₂ and CH₄ for the series of Durene:CARDO(Br) copolyimides showed an increase with an increase the molar ratio of Durene from 1:1 to 2:1 within the backbone of the copolymers. No further changes were seen when the molar ratio was increased to 3:1.

The CO₂/CH₄ diffusivity and solubility selectivity coefficients were calculated and the results are listed in Table 4 and Table 5, respectively. The CO₂/CH₄ diffusivity selectivity coefficients of the Durene:CARDO(Br) copolyimides were in the range of 1.53-1.97, while the CO₂/CH₄ selectivity coefficients were around 12, indicating that the separation through these polymeric membranes is solubility driven, which is in-line with the incorporation of the polar halogen group (i.e., bromine).

Mixed-Gas Permeation Measurement

Since natural gas is a mixture of different gases, it is desirable to measure the mixed-gas separation performance of the polymeric membranes. The permeation of gases through glassy polyimide membranes is affected by the presence of other gases in the flow. It is known that a small partial pressure of a condensable species such as CO₂ in the feed gas can significantly reduce the permeability of a gas relative to its permeability individually. Therefore, the competition for Langmuir sorption sites for non-plasticized polymers will lead to a decrease of all penetrants permeabilities. Moreover, the selectivity coefficients may also decrease because of bulk flow and the change on the dynamic free volume (plasticization). Therefore, the permeability of a gas i in the mixed gas permeation process is given by:

$${P}_{i} = {P}_{total} \frac{{y}_{i} ( {p}_{p} - {p}_{f} )}{{x}_{i} {p}_{p} - {y}_{i} {p}_{f}} \qquad ( 5 )$$

Pₜₒₜₐₗ is derived from the permeability expression for mixed gas:

$${P}_{total} = \frac{Jl}{Δ p} \qquad ( 6 )$$

The selectivity coefficient (α*ᵢⱼ), which is the ability of a polymeric membrane to separate a binary feed gas mixture, is defined as follows:

$${α}_{ij}^{*} = ( \frac{{y}_{i}}{{y}_{j}} ) ( \frac{{x}_{j}}{{x}_{i}} ) \qquad ( 7 )$$

where yᵢ and yⱼ are the mole fractions of gases i and j at the permeate side, and xᵢ and xⱼ are the mole fractions of gases i and j at the feed side.

To reflect the real properties of the membrane in the case of a non-ideal gas mixture, the modified expression of the selectivity (α_{i/j}^{m,*}) is represented by,

$${∝}_{i / j}^{m , *} = \frac{{P}_{i}^{*}}{{P}_{j}^{*}} \qquad ( 8 )$$

where P*ᵢ and P*ⱼ are the mixed gas permeability coefficients of components i and j determined by the fugacity driving force definition.

The mixed-gas separation performance of the prepared polymers were measured using a sweet gas mixture containing 10, 59, 30 and 1 vol. % of CO₂, CH₄, N₂ and C₂H₆, respectively. The permeation measurements were recorded at different feed pressures (300-900 psi) with an increment of 200 psi at a fixed temperature of 22° C. The results obtained are listed in Table 6.

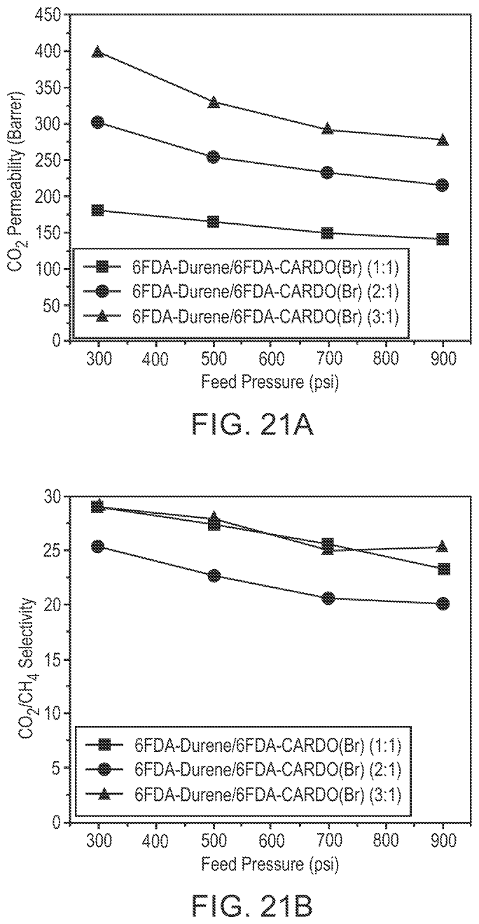

FIG. 21A is a plot comparing the effects of feed gas pressure on the CO₂ permeability of series of 6FDA-Durene/6FDA-CARDO(Br) copolyimides at three different composition ratios at 22° C. The CO₂ permeability coefficients tend to decrease with the increase on the feed pressure (from 300 to 900 psi). For example, the mixed-gas CO₂ permeability coefficient of 6FDA-Durene/6FDA-CARDO(Br) (1:1) decreased by 22% when the feed pressure increased from 300 psi to 900 psi.

FIG. 21B is a plot comparing the CO₂/CH₄ selectivity (right) coefficients of Durene:CARDO(Br) copolyimides at three different composition ratios at different feed pressures and 22° C. In a similar fashion, the CO₂ permeability coefficients of 6FDA-Durene/6FDA-CARDO(Br) (2:1) and 6FDA-Durene/6FDA-CARDO(Br) (3:1) decreased by 28% and 30%, respectively. This change on mixed-gas CO₂ permeability coefficients is attributed to the competition on Langmuir sorption sites between CO₂ and the other existing gases in the mixture (N₂, CH₄, and C₂H₆).

TABLE 6
Sweet mixed-gas permeability and selectivity coefficients of studied
polymers at various feed pressures and 22° C.

| | P | Permeability coefficients (Barrer) | | | | Selectivity coefficients | | |
|---|---|---|---|---|---|---|---|---|
| Polymer | (psi) | N₂ | CH₄ | C₂H₆ | CO₂ | N₂/CH₄ | C₂H₆/CH₄ | CO₂/CH₄ |
| 6FDA-Durene/6FDA- | 300 | 4.90 | 6.20 | 14.1 | 180 | 0.790 | 2.27 | 29.1 |
| CARDO(Br) (1:1) | 500 | 5.10 | 6.00 | 12.8 | 165 | 0.850 | 2.13 | 27.5 |
| | 700 | 5.00 | 5.80 | 13.0 | 149 | 0.862 | 2.24 | 25.6 |
| | 900 | 4.70 | 6.00 | 16.7 | 141 | 0.783 | 2.78 | 23.4 |
| 6FDA-Durene/6FDA- | 300 | 10.1 | 11.9 | 14.6 | 302 | 0.849 | 1.23 | 25.4 |
| CARDO(Br) (2:1) | 500 | 9.10 | 11.2 | 25.2 | 255 | 0.813 | 2.25 | 22.8 |
| | 700 | 9.10 | 11.2 | 40.1 | 232 | 0.813 | 3.58 | 20.7 |
| | 900 | 9.30 | 10.7 | 23.9 | 217 | 0.869 | 2.23 | 20.2 |
| 6FDA-Durene/6FDA- | 300 | 13.4 | 13.7 | 16.4 | 399 | 0.978 | 1.20 | 29.1 |
| CARDO(Br) (3:1) | 500 | 11.0 | 11.8 | 17.9 | 331 | 0.932 | 1.52 | 28.0 |
| | 700 | 10.3 | 11.6 | 23.2 | 292 | 0.888 | 2.00 | 25.1 |
| | 900 | 10.5 | 11.0 | 24.8 | 278 | 0.955 | 2.25 | 25.3 |
| 6FDA-DAM/6FDA- | 300 | 9.60 | 11.3 | 22.4 | 312 | 0.850 | 1.98 | 27.6 |
| CARDO(Br) (3:1) | 500 | 9.10 | 10.4 | 21.0 | 243 | 0.875 | 2.02 | 23.4 |
| | 700 | 9.10 | 9.30 | 41.1 | 225 | 0.978 | 4.42 | 24.2 |
| | 900 | 7.30 | 9.20 | 37.6 | 207 | 0.793 | 4.09 | 22.5 |

As a result of the decrease on the mixed-gas CO₂ permeability coefficients with slight changes in mixed-gas CH₄ permeability coefficients, the CO₂/CH₄ selectivity coefficients decreased when the pressure increased from 300 to 900 psi for all copolyimides, as shown in FIGS. 21A and 21B. It can be noted that the mixed-gas CO₂/CH₄ selectivity showed a clear dependence of the overall molar ratio of comonomers, but independent of their nature. For example, for the copolyimides with Durene:CARDO(Br) of 1:1 and 3:1, the CO₂/CH₄ selectivity coefficients appear to be the same, however, for the 6FDA-Durene/6FDA-CARDO(Br) (2:1) copolyimide, the CO₂/CH₄ selectivity appeared to be 13-20% lower. These results of permeability and selectivity at such elevated feed pressures and for such a multicomponent gas mixture, make of the Durene:CARDO(Br) series of copolyimides attractive potential materials for industrial natural gas sweetening applications.

Further, membranes prepared from 6FDA-DAM/6FDA-CARDO(Br) (3:1) were studied in a similar fashion to that of Durene/CARDO(Br) series using the same gas mixture composition and same testing conditions of pressure and temperature. The obtained data are listed in Table 6.

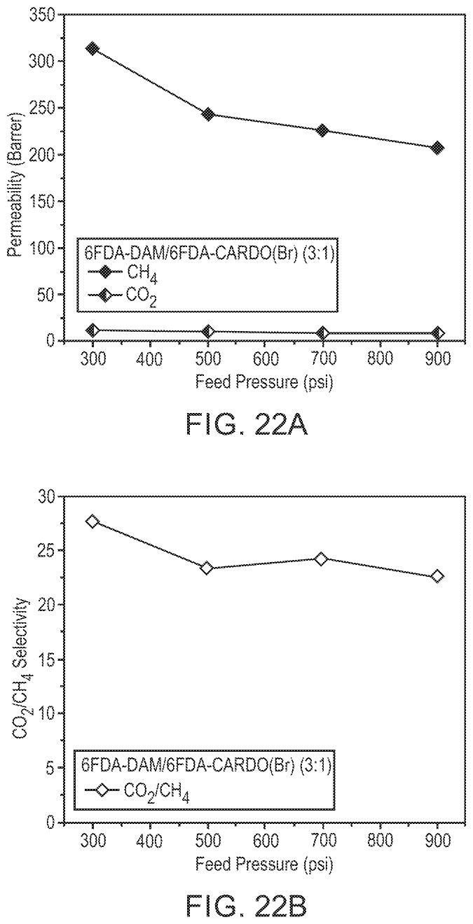

FIG. 22A is a plot of the effect of feed gas pressure on the sweet mixed-gas CO₂ and CH₄ permeability of 6FDA-DAM/6FDA-CARDO(Br) (3:1) copolyimide at 22° C. As can be seen from FIG. 22A, the mixed-gas CO₂ permeability coefficient decreased with an increase on feed pressure from 300 psi to 900 psi. The decrease on the CO₂ permeability coefficients is attributed to the competition on Langmuir sorption sites between CO₂ and the other existing gases in the mixture.

FIG. 22B is a plot of the effect of feed gas pressure on the CO₂/CH₄ selectivity coefficients of 6FDA-DAM/6FDA-CARDO(Br) (3:1) copolyimide at 22° C. The corresponding CO₂/CH₄ selectivity coefficients of 6FDA-DAM/6FDA-CARDO(Br) (3:1) at various feed pressures depict a decrease with an increase of the feed pressure from 300 psi to 900 psi. This change is attributed to the prominent change in CO₂ permeability coefficients with slight change on the CH₄ permeability

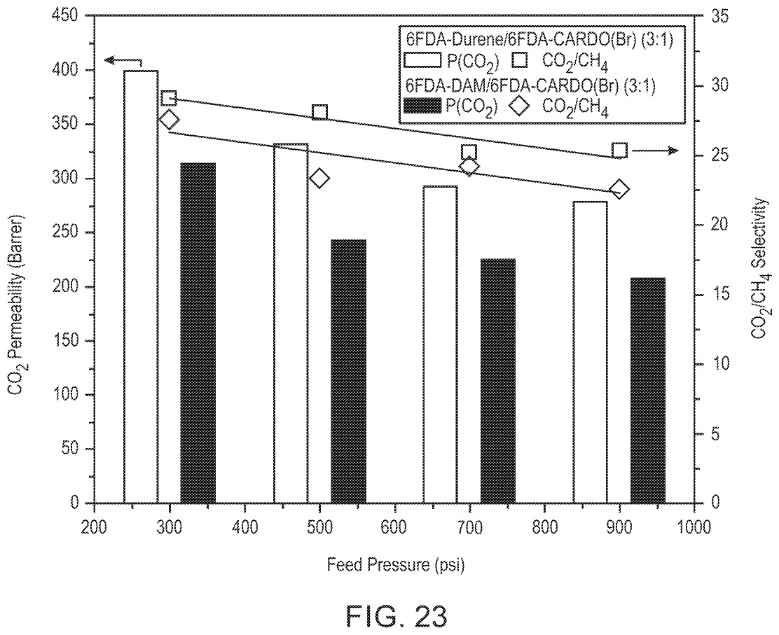

FIG. 23 is a plot showing a comparison between sweet mixed-gas CO₂ permeability and CO₂/CH₄ selectivity coefficients of 6FDA-Durene/6FDA-CARDO(Br) (3:1) and 6FDA-DAM/6FDA-CARDO(Br) (3:1) copolyimides at different feed pressures and 22° C. As can be seen from FIG. 23, the performance of a membrane prepared from a 6FDA-Durene/6FDA-CARDO(Br) (3:1) copolyimide is superior to that of a membrane prepared from 6FDA-DAM/6FDA-CARDO(Br) (3:1), both for permeability and selectivity coefficients. All membranes prepared from the polymers described herein were resistant to plasticization or swelling at elevated feed pressures, such as 900 psi.

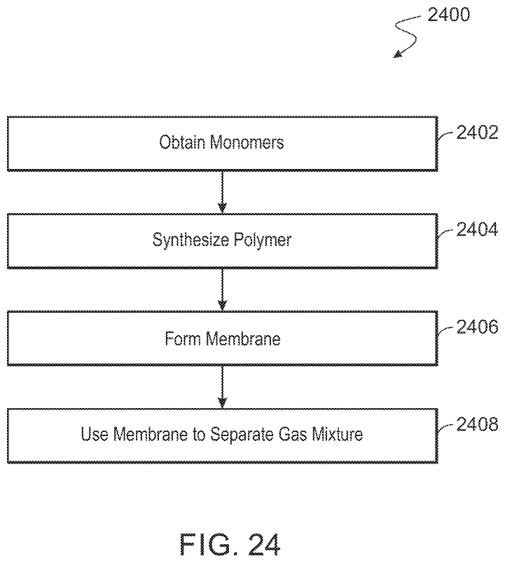

FIG. 24 is a method 2400 for synthesizing and using a polymer for forming a membrane to separate a gas mixture. The method 2400 begins at block 2402 with the synthesis or purchase of the monomers. This may be performed by the techniques described herein. At block 2404, the polymer used for the membrane is synthesized, for example, using the techniques described herein. At block 2406, a membrane is formed from the polymer, for example, using the solvent evaporation techniques described herein. At block 2408, the membrane is used to separate gas mixtures, for example, to sweeten natural gas by the separation of acid gases, such as H₂S, CO₂, or COS.

### Embodiments

Embodiments described in examples herein provide a gas separation membrane including a polyimide polymer including a monomer having a structure including:

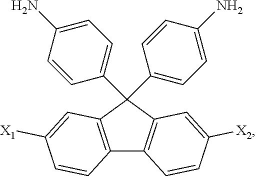

wherein when X₁=X₂, X₁ and X₂ are selected from F, Cl, Br, or I and wherein when X₁ and X₂ are different elements, X₁ and X₂ are independently selected from H, F, Cl, Br, or I.

In aspect the gas separation membrane includes a homopolymer of the structure:

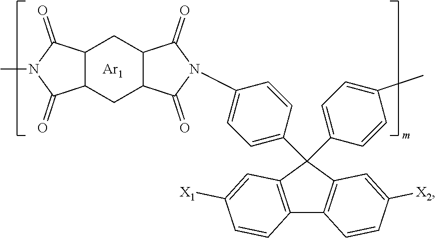

wherein Ar₁ includes an aromatic moiety or a bridging moiety.

In an aspect, the gas separation membrane includes a copolymer of the structure:

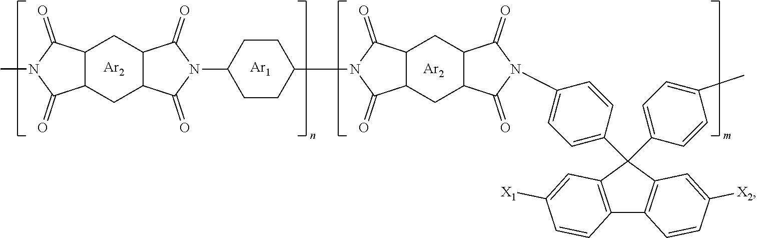

wherein Ar₁ and Ar₂ independently include aromatic moieties, bridging moieties, or both, and the ratio of n to m is between 3:1 and 1:3.

In an aspect, the gas separation membrane includes a random copolymer.

In an aspect, the gas separation membrane includes a block copolymer.

In an aspect, the gas separation membrane includes an oligomer of the structure:

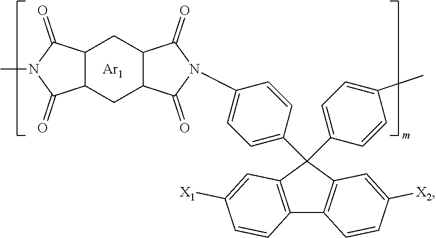

wherein Ar₁ includes an aromatic moiety or a bridging moiety.

In an aspect, the gas separation membrane includes a homopolymer of the structure:

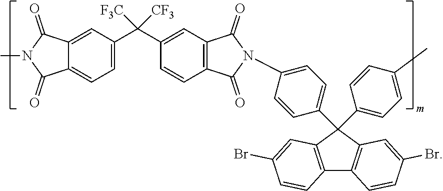

In an aspect, the gas separation membrane includes a copolymer of the structure:

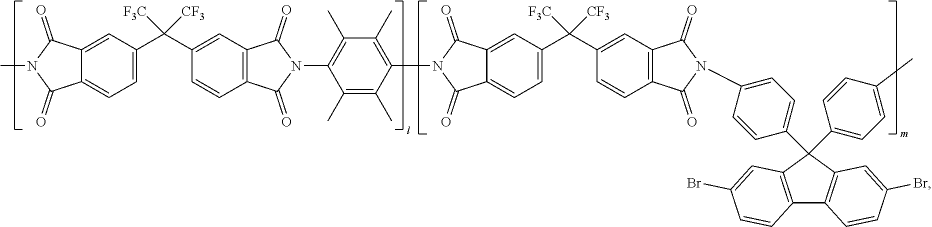

where the ratio between 1 and m is between 1:3 and 3:1.

In an aspect, the gas separation membrane includes a random copolymer.

In an aspect, the gas separation membrane includes a block copolymer.

In an aspect, the gas separation membrane includes a monomer of the structure:

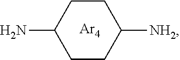

wherein Ar₄ includes an aromatic moiety or a bridging moiety

In an aspect, the gas separation membrane includes a monomer of the structure:

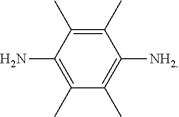

In an aspect, the gas separation membrane includes a monomer of the structure:

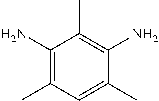

In an aspect, the gas separation membrane includes a monomer with the structure:

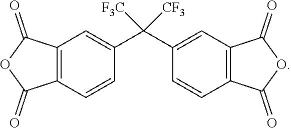 [SMILES: O=C1OC(=O)c2cc(C(c3ccc4c(c3)C(=O)OC4=O)(C(F)(F)F)C(F)(F)F)ccc21]

In an aspect, the gas separation membrane includes an oligomer with the structure:

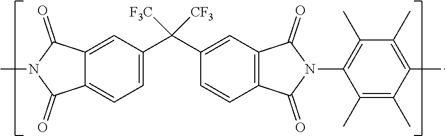

Another embodiment described in examples herein provides a method for forming a gas separation membrane. The method includes obtaining a halogen-substituted 9,9-bis(4-aminophenyl)fluorene (CARDO) monomer and obtaining an dianhydride monomer. The halogen-substituted 9,9-bis(4-aminophenyl)fluorene (CARDO) monomer is reacted with the dianhydride monomer to form a polymer. The polymer is dissolved in a solvent to form a polymer solution. A film is formed from the polymer solution. The film is dried to form the gas separation membrane.

In an aspect, the halogen-substituted 9,9-bis(4-aminophenyl)fluorene (CARDO) monomer is formed by the reaction scheme:

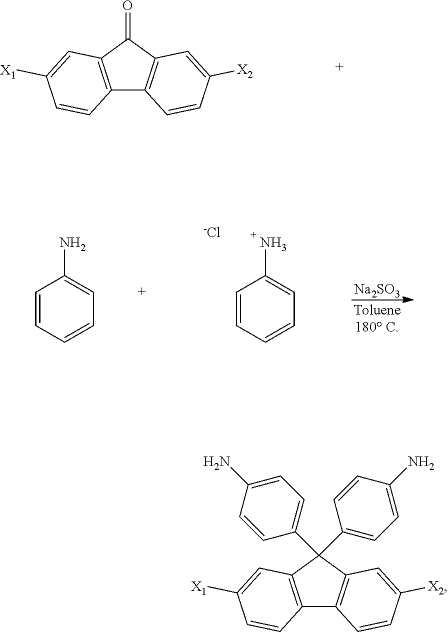

wherein when X₁=X₂, X₁ and X₂ are selected from F, Cl, Br, or I and wherein when X₁ and X₂ are different elements, X₁ and X₂ are independently selected from H, F, Cl, Br, or I.

In an aspect, the halogen-substituted 9,9-bis(4-aminophenyl)fluorene (CARDO) monomer includes:

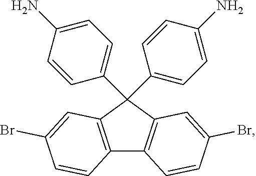 [SMILES: Nc1ccc(C2(c3ccc(N)cc3)c3cc(Br)ccc3-c3ccc(Br)cc32)cc1]

In an aspect, the halogen-substituted 9,9-bis(4-aminophenyl)fluorene (CARDO) monomer includes:

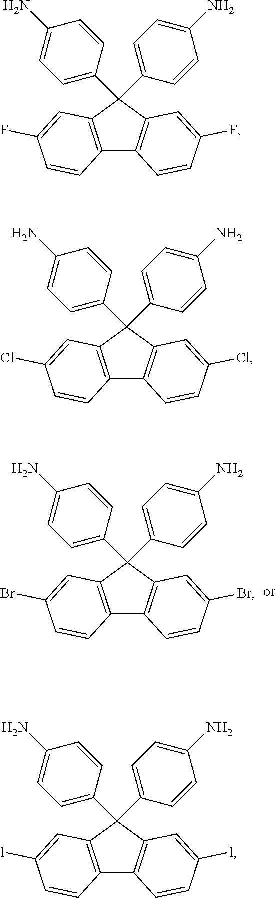

or any combinations thereof.

In an aspect, the halogen-substituted 9,9-bis(4-aminophenyl)fluorene (CARDO) monomer includes:

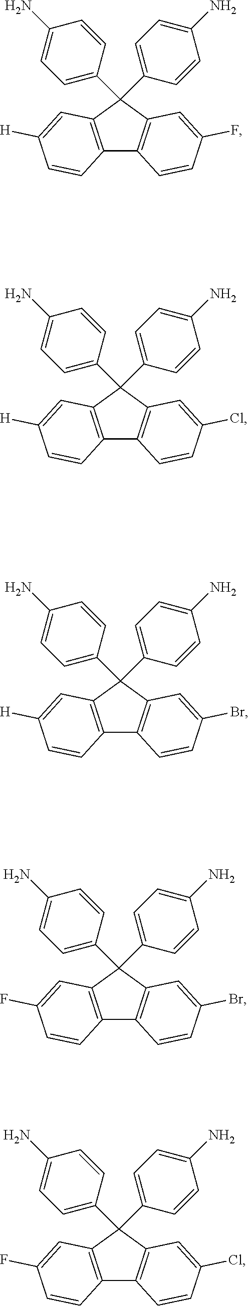 [SMILES: Nc1ccc(C2(c3ccc(N)cc3)c3ccccc3-c3ccc(F)cc32)cc1 ; Nc1ccc(C2(c3ccc(N)cc3)c3ccccc3-c3ccc(Cl)cc32)cc1 ; Nc1ccc(C2(c3ccc(N)cc3)c3ccccc3-c3ccc(Br)cc32)cc1 ; Nc1ccc(C2(c3ccc(N)cc3)c3cc(F)ccc3-c3ccc(Br)cc32)cc1 ; Nc1ccc(C2(c3ccc(N)cc3)c3cc(F)ccc3-c3ccc(Cl)cc32)cc1]

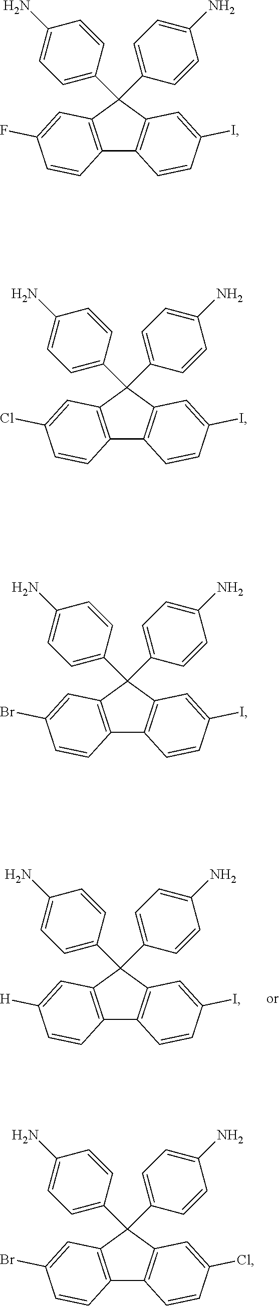 [SMILES: Nc1ccc(C2(c3ccc(N)cc3)c3cc(F)ccc3-c3ccc(I)cc32)cc1 ; Nc1ccc(C2(c3ccc(N)cc3)c3cc(Cl)ccc3-c3ccc(I)cc32)cc1 ; Nc1ccc(C2(c3ccc(N)cc3)c3cc(Br)ccc3-c3ccc(I)cc32)cc1 ; Nc1ccc(C2(c3ccc(N)cc3)c3ccccc3-c3ccc(I)cc32)cc1 ; Nc1ccc(C2(c3ccc(N)cc3)c3cc(Cl)ccc3-c3ccc(Br)cc32)cc1]

or any combinations thereof.

In an aspect, the dianhydride monomer includes:

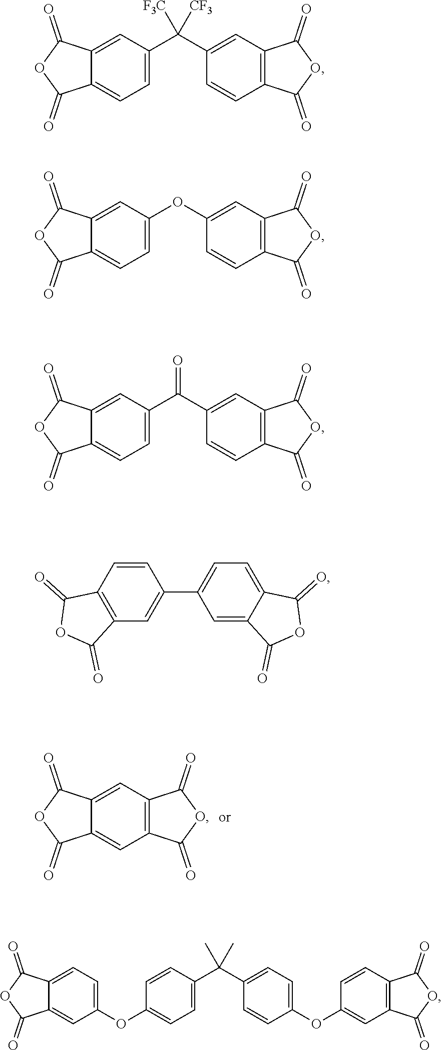 [SMILES: O=C1OC(=O)c2cc(C(c3ccc4c(c3)C(=O)OC4=O)(C(F)(F)F)C(F)(F)F)ccc21 ; O=C1OC(=O)c2cc(Oc3ccc4c(c3)C(=O)OC4=O)ccc21 ; O=C(c1ccc2c(c1)C(=O)OC2=O)c1ccc2c(c1)C(=O)OC2=O ; O=C1OC(=O)c2cc(-c3ccc4c(c3)C(=O)OC4=O)ccc21 ; O=c1oc(=O)c2cc3c(=O)oc(=O)c3cc12 ; CC(C)(c1ccc(Oc2ccc3c(c2)C(=O)OC3=O)cc1)c1ccc(Oc2ccc3c(c2)C(=O)OC3=O)cc1]

or any combinations thereof,

In an aspect, the polymer is formed by heating the halogen-substituted 9,9-bis(4-aminophenyl)fluorene (CARDO) monomer, the dianhydride monomer, and an aromatic diamine.

In an aspect, the aromatic diamine comprises

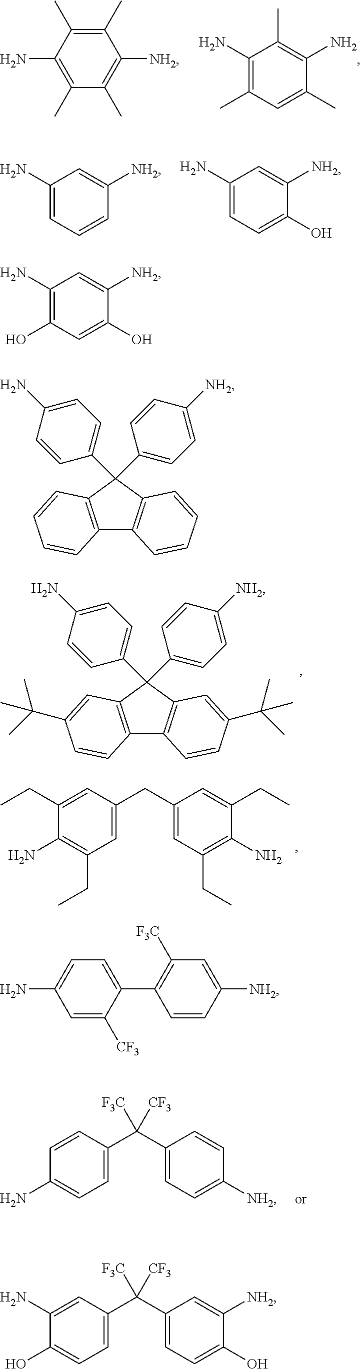

or any combinations thereof.

Other implementations are also within the scope of the following claims.

What is claimed is:

1. A gas separation membrane comprising a polyimide polymer comprising a monomer having a structure comprising: 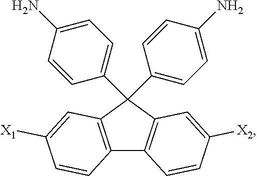
wherein when X₁=X₂, X₁ and X₂ are selected from F, Cl, Br, or I and wherein when X₁ and X₂ are different elements, X₁ and X₂ are independently selected from H, F, Cl, Br, or I.

2. The gas separation membrane of claim 1, comprising a homopolymer of the structure: 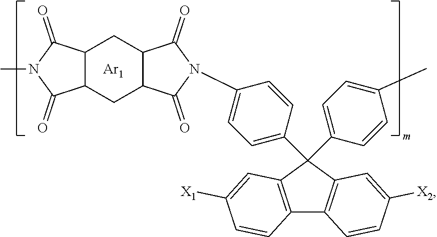
wherein Ar₁ comprises an aromatic moiety or a bridging moiety.

3. The gas separation membrane of claim 1, comprising a copolymer of the structure: 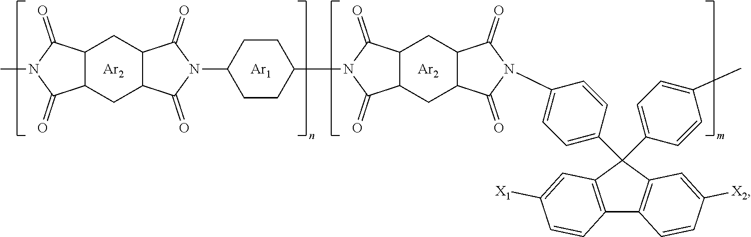
wherein Ar₁ and Ar₂ independently comprise aromatic moieties, bridging moieties, or both, and the ratio of n to m is between 3:1 and 1:3.

4. The gas separation membrane of claim 3, comprising a random copolymer.

5. The gas separation membrane of claim 3, comprising a block copolymer.

6. The gas separation membrane of claim 1, comprising an oligomer of the structure: 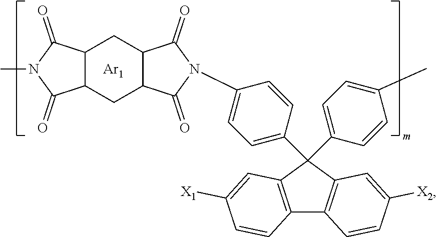
wherein Ar₁ comprises an aromatic moiety or a bridging moiety.

7. The gas separation membrane of claim 1, comprising a homopolymer of the structure:

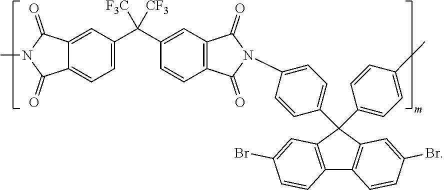

8. The gas separation membrane of claim 1, comprising a copolymer of the structure: 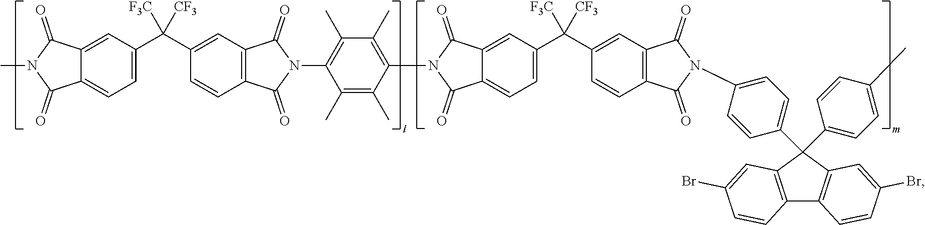
wherein the ratio between 1 and m is between 1:3 and 3:1.

9. The gas separation membrane of claim 8, comprising a random copolymer.

10. The gas separation membrane of claim 8, comprising a block copolymer.

11. The gas separation membrane of claim 1, comprising a monomer of the structure: 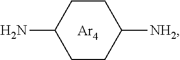
wherein Ar₄ comprises an aromatic moiety or a bridging moiety

12. The gas separation membrane of claim 1, comprising a monomer of the structure:

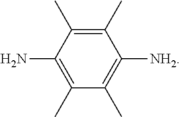

13. The gas separation membrane of claim 1, comprising a monomer of the structure:

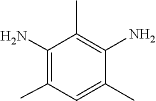

14. The gas separation membrane of claim 1, comprising a monomer with the structure:

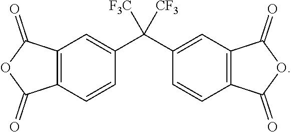 [SMILES: O=C1OC(=O)c2cc(C(c3ccc4c(c3)C(=O)OC4=O)(C(F)(F)F)C(F)(F)F)ccc21]

15. The gas separation membrane of claim 1, comprising an oligomer with the structure:

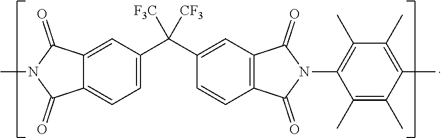

16. A method for forming a gas separation membrane, comprising:
obtaining a halogen-substituted 9,9-bis(4-aminophenyl)fluorene (CARDO) monomer;
obtaining an dianhydride monomer;
reacting the halogen-substituted 9,9-bis(4-aminophenyl)fluorene (CARDO) monomer with the dianhydride monomer to form a polymer;
dissolving the polymer in a solvent to form a polymer solution;
forming a film from the polymer solution; and
drying the film to form the gas separation membrane.

17. The method of claim 16, wherein the halogen-substituted 9,9-bis(4-aminophenyl)fluorene (CARDO) monomer is formed by the reaction scheme: 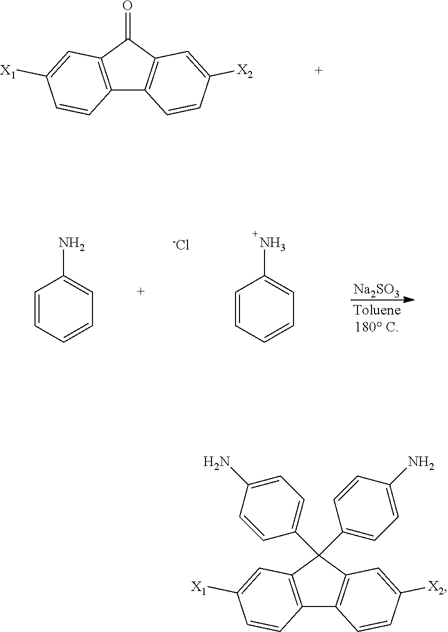
wherein when X₁=X₂, X₁ and X₂ are selected from F, Cl, Br, or I and wherein when X₁ and X₂ are different elements, X₁ and X₂ are independently selected from H, F, Cl, Br, or I.

18. The method of claim 16, wherein the halogen-substituted 9,9-bis(4-aminophenyl)fluorene (CARDO) monomer comprises:

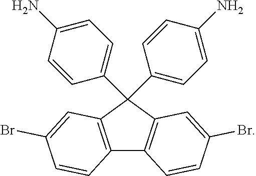 [SMILES: Nc1ccc(C2(c3ccc(N)cc3)c3cc(Br)ccc3-c3ccc(Br)cc32)cc1]

19. The method of claim 16, wherein the halogen-substituted 9,9-bis(4-aminophenyl)fluorene (CARDO) monomer comprises: 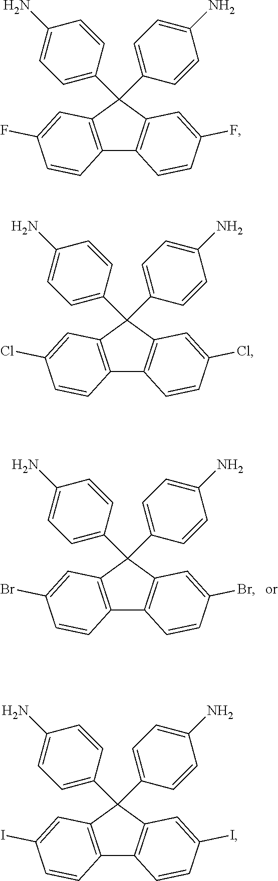 [SMILES: Nc1ccc(C2(c3ccc(N)cc3)c3cc(F)ccc3-c3ccc(F)cc32)cc1 ; Nc1ccc(C2(c3ccc(N)cc3)c3cc(Cl)ccc3-c3ccc(Cl)cc32)cc1 ; Nc1ccc(C2(c3ccc(N)cc3)c3cc(Br)ccc3-c3ccc(Br)cc32)cc1 ; Nc1ccc(C2(c3ccc(N)cc3)c3cc(I)ccc3-c3ccc(I)cc32)cc1]
or any combinations thereof.

20. The method of claim 16, wherein the halogen-substituted 9,9-bis(4-aminophenyl)fluorene (CARDO) monomer comprises: 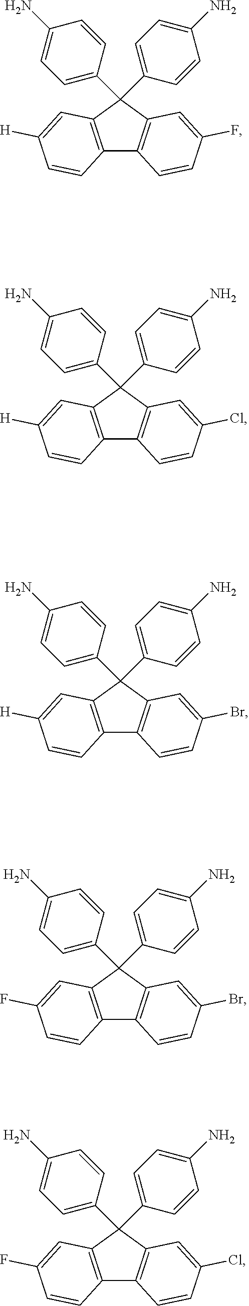 [SMILES: Nc1ccc(C2(c3ccc(N)cc3)c3ccccc3-c3ccc(F)cc32)cc1 ; Nc1ccc(C2(c3ccc(N)cc3)c3ccccc3-c3ccc(Cl)cc32)cc1 ; Nc1ccc(C2(c3ccc(N)cc3)c3ccccc3-c3ccc(Br)cc32)cc1 ; Nc1ccc(C2(c3ccc(N)cc3)c3cc(F)ccc3-c3ccc(Br)cc32)cc1 ; Nc1ccc(C2(c3ccc(N)cc3)c3cc(F)ccc3-c3ccc(Cl)cc32)cc1] 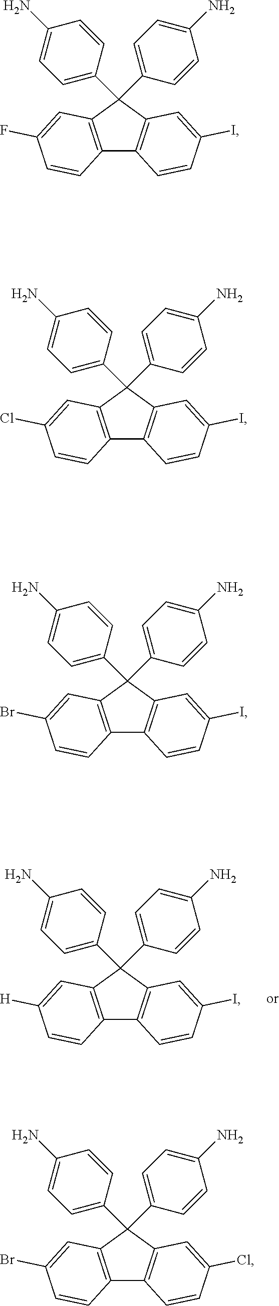 [SMILES: Nc1ccc(C2(c3ccc(N)cc3)c3cc(F)ccc3-c3ccc(I)cc32)cc1 ; Nc1ccc(C2(c3ccc(N)cc3)c3cc(Cl)ccc3-c3ccc(I)cc32)cc1 ; Nc1ccc(C2(c3ccc(N)cc3)c3cc(Br)ccc3-c3ccc(I)cc32)cc1 ; Nc1ccc(C2(c3ccc(N)cc3)c3ccccc3-c3ccc(I)cc32)cc1 ; Nc1ccc(C2(c3ccc(N)cc3)c3cc(Cl)ccc3-c3ccc(Br)cc32)cc1]
or any combinations thereof,

21. The method of claim 16, wherein the dianhydride monomer comprises: 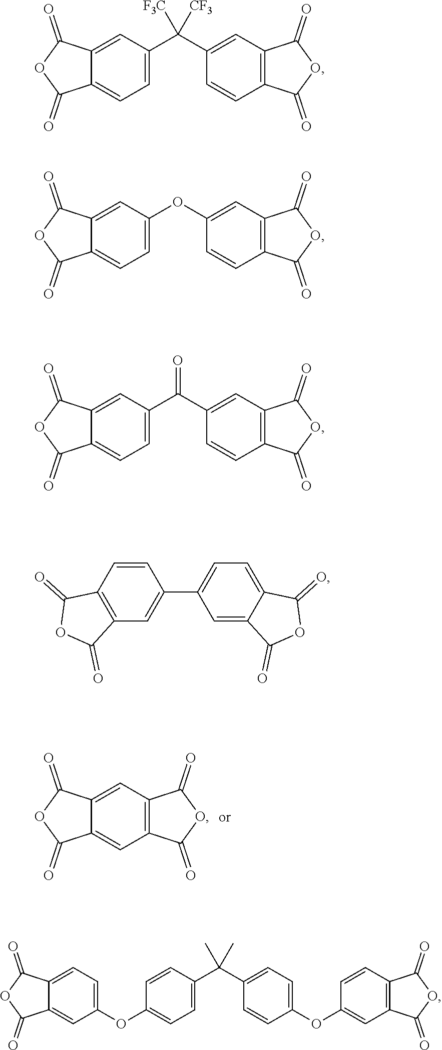 [SMILES: O=C1OC(=O)c2cc(C(c3ccc4c(c3)C(=O)OC4=O)(C(F)(F)F)C(F)(F)F)ccc21 ; O=C1OC(=O)c2cc(Oc3ccc4c(c3)C(=O)OC4=O)ccc21 ; O=C(c1ccc2c(c1)C(=O)OC2=O)c1ccc2c(c1)C(=O)OC2=O ; O=C1OC(=O)c2cc(-c3ccc4c(c3)C(=O)OC4=O)ccc21 ; O=c1oc(=O)c2cc3c(=O)oc(=O)c3cc12 ; CC(C)(c1ccc(Oc2ccc3c(c2)C(=O)OC3=O)cc1)c1ccc(Oc2ccc3c(c2)C(=O)OC3=O)cc1]
or any combinations thereof.

22. The method of claim 16, wherein the polymer is formed by heating the halogen-substituted 9,9-bis(4-aminophenyl)fluorene (CARDO) monomer, the dianhydride monomer, and an aromatic diamine.

23. The method of claim 22, wherein the aromatic diamine comprises 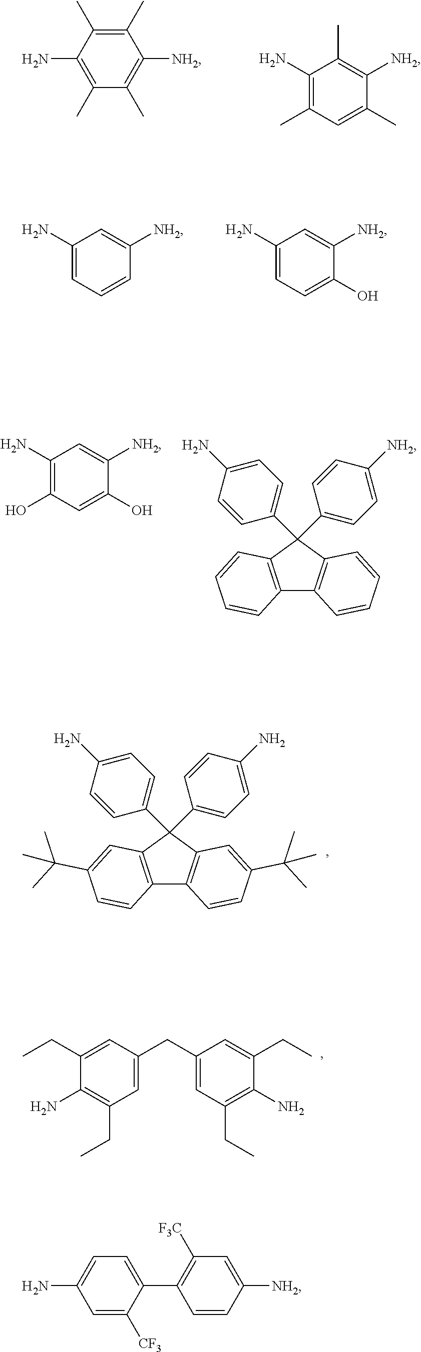 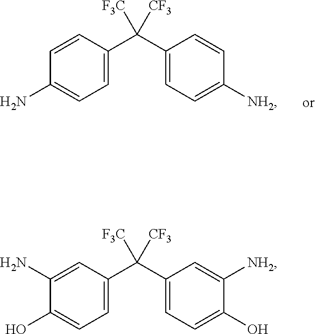 [SMILES: Nc1ccc(C(c2ccc(N)cc2)(C(F)(F)F)C(F)(F)F)cc1 ; Nc1cc(C(c2ccc(O)c(N)c2)(C(F)(F)F)C(F)(F)F)ccc1O]
or any combinations thereof.
